(19) United States
(12) Patent Application Publication
(10) Pub. No.: US 2005/0136270 A1
(43) Pub. Date: Jun. 23, 2005

(54) Method of controlling thermal waves in reactive multilayer joining and resulting product

(76) Inventors: Etienne Besnoin, Baltimore, MD (US); Jiaping Wang, Vienna, VA (US); Alan Duckham, Baltimore, MD (US); Stephen John Spey JR., Baltimore, MD (US); David Peter Van Heerden, Baltimore, MD (US); Timothy P. Weihs, Baltimore, MD (US); Omar M. Knio, Timonium, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/843,352

(22) Filed: May 12, 2004

Related U.S. Application Data
(60) Provisional application No. 60/469,841, filed on May 13, 2003.

(51) Int. Cl. B32B 15/04; B32B 9/00

(52) U.S. Cl. 428/469; 428/615; 428/621

(57) ABSTRACT

An embodiment of the invention includes a method of simulating a behavior of an energy distribution within a soldered or brazed assembly to predict various physical parameters of the assembly. The assembly typically includes a reactive multilayer material. The method comprises the steps of providing an energy evolution equation having an energy source term associated with a self-propagating reaction that originates within the reactive multilayer material. The method also includes the steps of discretizing the energy evolution equation, and determining the behavior of the energy distribution in the assembly by integrating the discretized energy evolution equation using other parameters associated with the assembly.

### CROSS-REFERENCE TO RELATED APPLICATION

This application claims the benefits of priority under 35 U.S.C. §119(e) to U.S. Provisional Patent Application No. 60/469,841, the entirety of which is incorporated herein by reference.

### STATEMENT REGARDING FEDERALLY SPONSORED RESEARCH

This invention was made with U.S. Government support under National Science Foundation Award Nos. DMI-0115238, DMI-0215109, and U.S. Army Contract No. DAAD17-03-C-0052. The U.S. Government has certain rights in this invention.

### DESCRIPTION OF THE INVENTION

1. Field of the Invention

The invention is directed toward methods of selecting components for a reactive joining process and their respective configurations based on simulated data so as to produce a joint with desired properties. The invention is also directed towards joints produced by implementing such methods.

2. Background of the Invention

Reactive multilayer joining is a particularly advantageous process for soldering, brazing or welding materials. A typical reactive multilayer joining process is schematically illustrated in FIG. 1. This room-temperature bonding process is based on sandwiching under pressure a reactive multilayer foil 1000 between two layers of a fusible material 1001 and the two components 1002 to be joined, and then igniting the foil 1000, for example, using a spark 1003. A self-propagating reaction is thus initiated which results in a rapid rise in the temperature of the reactive foil 1000. The heat released by the reaction melts the fusible-material layers 1001, and upon cooling, bonds the two components 1002. This method of soldering or brazing is far more rapid than conventional techniques that utilize furnaces or torches. Thus, significant gains in productivity can be achieved. In addition, with very localized heating, temperature sensitive components, as well as dissimilar materials such as metals and ceramics, can be joined without thermal damage.

Soldering or brazing using reactive foils is fast and heat generated by the nanofoil is localized to the joint area. Reactive foils are particularly advantageous in applications involving temperature-sensitive components, or metal/ceramic bonding. Specifically, when welding or brazing, temperature-sensitive components can be destroyed or damaged during the process, and thermal damage to the materials may necessitate costly and time-consuming operations, such as subsequent anneals or heat treatments. In contrast, when joining of the temperature-sensitive components is effected with reactive multilayers, the joined components are subject to little heat and small, limited-duration, increases in temperature. Only the braze layers and the surfaces of the components are heated substantially, and little, if any, thermal damage occurs. In addition, the reactive joining process is fast, and results in cost-effective, strong, and thermally-conductive joints. Substantial commercial advantages can thus be achieved, for example, in assembling of fiber optic components, hermetic sealing applications, and mounting heat sinks.

Brazing is preferred for high-end metal-ceramic bonding, and brazing is accomplished by placing a braze between the metal and the ceramic and inserting the entire assembly into a furnace. Upon cooling, however, substantial differences in the coefficients of thermal expansion (CTE) of the metal and the ceramic causes large thermal stresses between the metal and the ceramic. For example, when cooling a metal-ceramic bond from brazing temperatures of ˜700° C., the metallic components contract more than the ceramic components. This disparity causes thermal stresses between the metallic and ceramic components, and thus causes de-bonding or de-lamination of these components. Consequently, the size of conventionally soldered or brazed metal/ceramic joints are limited to areas as small as 1.0 square inch. When using reactive foils to bond the metallic and ceramic components the metallic and ceramic components are not heated substantially. As a result, little thermal contraction mismatch and delamination occur. Thus, reactive joining offers advantageous techniques for obtaining strong, large-area metal-ceramic joints.

The reactive multilayers used in the reactive joining process are nanostructured materials that are typically fabricated by vapor depositing hundreds of nanoscale layers that alternate between elements with large, negative heats of mixing such as Ni and Al. Various implementations of these methods are disclosed in the following publications, the entirety of all of which are incorporated herein by reference: U.S. Pat. No. 5,381,944 to Makowiecki et al. (“Makowiecki”); U.S. Pat. No. 5,538,795; U.S. Pat. No. 5,547,715; an article by Besnoin et al. entitled “Effect of Reactant and Product Melting on Self-Propagating Reactions in Multilayer Foils” published in the Journal of Applied Physics, Vol. 92(9), pages 5474-5481 on Nov. 1, 2002 (“Besnoin”); an article entitled “Deposition and Characterization of a Self-Propagating CuOx/Al Thermite Reaction in a Multilayer Foil Geometry” published in the Journal of Applied Physics, Vol. 94(5) on Sep. 1, 2003; U.S. Pat. No. 5,381,944; U.S. patent application Ser. No. 09/846,486 filed May 1, 2001 and entitled “Free Standing Reactive Multilayer Foils”; U.S. Provisional Patent Application No. 60/201,292 filed on May 2, 2000 and entitled “Free Standing Reactive Multilayer Foils”; a chapter entitled “Self-Propagating Reactions in Multilayer Materials” published in the 1998 edition of the Handbook of Thin Film Process Technology edited by D. A. Glocker and S. I. Shah (“Glocker”); and an article entitled “Self-Propagating Exothermic Reactions in Nanoscale Multilayer Materials” that was presented at The Minerals, Metals, and Materials Society (TMS) Proceeding on Nanostructures in February of 1997.

Makowiecki discloses that the reactive multilayers were deposited directly onto one of the surfaces of the components, and the selection of alternating materials was primarily based on the heat of the corresponding reaction. The design methodology set forth in Makowiecki is based on the assumption that, following ignition, the reactive multilayer foil and the fusible material rapidly come to thermal equilibrium. This assumption enabled the development of a simplified methodology that accounts for the reaction heat, the density and heat capacity of the foil, as well as the density and heat capacity of the fusible material. This approach, however, is generally unsuitable for properly determining adequate configurations of reactive joining, and for controlling thermal transport during the reactive joining process.

Subsequent developments, however, have shown that it is possible to carefully control both the heat of the reaction as well as the reaction velocity, and have also provided alternative means for fabricating nanostructured multilayers. For instance, it has been demonstrated that the velocities, heats, and temperatures of the reactions can be controlled by varying the thicknesses of the alternating layers. Examples of such demonstrations are disclosed in the following publications, the entirety of all of which are incorporated herein by reference: U.S. Pat. No. 5,538,795; an article entitled “The Combustion Synthesis of Multilayer NiAl Systems” published in Scripta Metallurgica et Materialia, Vol. 30(10), pages 1281-1286 in 1994; an article by Gavens et al. entitled “Effects of Intermixing on Self-Propagating Exothermic Reactions in Al/Ni Nanolaminate Nanofoils” published in the Journal of Applied Physics, Vol. 87(3), pages 1255-1263 on Feb. 1, 2000 (“Gavens”); U.S. patent application Ser. No. 09/846,486 filed May 1, 2001; and U.S. Provisional Patent Application No. 60/201,292 filed on May 2, 2000 and entitled “Free Standing Reactive Multilayer Foils.”

It has also been shown that the heats of reaction can be controlled by modifying the foil composition, or by low-temperature annealing of the reactive multilayers after their fabrication, as disclosed in an article entitled “Effects of Intermixing on Self-Propagating Exothermic Reactions in Al/Ni Nanolaminate Foils” published in the Journal of Applied Physics, Vol. 87(3), pages 1255-1263 on Feb. 1, 2000, the entirety of which is incorporated herein by reference. Alternative methods for fabricating nanostructured reactive multilayers include: (i) mechanical processing, which is disclosed in U.S. Pat. No. 6,534,194, and (ii) electrochemical deposition.

Although techniques for control of reaction heats, velocities, and temperatures, and alternative fabrication methods are known, new design methodologies that are suitable for both known and new reactive joining configurations are needed. For example, several variables that can be controlled are not accounted for in Makowiecki (e.g., the reaction velocity and temperature, the thermal conductivities of the reactive foil, the fusible material and the components, and/or the density and heat capacity of the components).

Moreover, a design methodology is needed to address joining using foils obtained with new fabrication methods, such as free-standing reactive multilayers, and to improve adhesion between the foil and the layers of fusible material or the components.

Accordingly, as will be described below, one of the primary objectives of the present invention is to provide means for controlling thermal transport during reactive joining, and to identify preferred configurations resulting from the application of the new methodology.

### SUMMARY OF THE INVENTION

An embodiment of the invention includes a method of simulating a behavior of an energy distribution within an assembly containing a reactive multilayer material. The method comprises the steps of, providing an energy evolution equation, the energy evolution equation including an energy source term associated with a self-propagating reaction that originates within the reactive multilayer material, the self-propagating reaction having a known speed and heat of reaction, discretizing the energy evolution equation, and determining the behavior of the energy distribution in the assembly by integrating the discretized energy evolution equation using parameters associated with the assembly.

Another embodiment of the invention includes a program storage device readable by a machine, tangibly embodying a program of instructions executable by the machine to perform method steps for simulating a behavior of an energy distribution within an assembly containing a reactive multilayer material. The method comprises the steps of providing an energy evolution equation, the energy evolution equation including an energy source term associated with a self-propagating reaction that originates within the reactive multilayer material, the self-propagating reaction having a known speed and heat of reaction, discretizing the energy evolution equation, and determining the behavior of the energy distribution in the assembly by integrating the discretized energy evolution equation using parameters associated with the assembly.

A further embodiment of the invention includes a method comprising selecting a reactive multilayer material, selecting a first component and a second component for joining using the reactive multilayer material, providing an energy evolution equation, the energy evolution equation including an energy source term associated with a self-propagating reaction that originates within the reactive multilayer material, the self-propagating reaction having a known speed and heat of reaction, discretizing the energy evolution equation, determining a behavior of an energy distribution in the first component, the second component, and the reactive multilayer material by integrating the discretized energy evolution equation using parameters associated with at least one of the first component, the second component, and the reactive multilayer material, providing the first component, the second component, and the reactive multilayer material having the parameters, positioning the reactive multilayer material between the first component and the second component, and chemically transforming the reactive multilayer material so as to join the first component to the second component.

Yet another embodiment of the invention includes a method. The method comprises providing parameters associated with a first component, a second component, and a reactive multilayer material. The parameters have been determined by a method comprising the steps of providing an energy evolution equation, the energy evolution equation including an energy source term associated with a self-propagating reaction that originates within the reactive multilayer material, the self-propagating reaction having a known speed and heat of reaction, discretizing the energy evolution equation, and determining a behavior of an energy distribution in the first component, the second component, and the reactive multilayer material by integrating the discretized energy evolution equation using the parameters associated with at least one of the first component, the second component, and the reactive multilayer material. The method further comprises providing the first component, the second component, and the reactive multilayer material having the parameters, positioning the reactive multilayer material between the first component and the second component, and chemically transforming the reactive multilayer material so as to join the first component to the second component.

A yet further embodiment of the invention includes a joint. The joint comprises a first component joined to a second component and remnants of a chemical transformation of a reactive multilayer material associated with the first component and the second component. Parameters of at least one of the first component, the second component, and the reactive multilayer material is predetermined based on a simulated behavior of an energy distribution within the first component, the second component, and the reactive multilayer material. The behavior is determined by integrating a discretization of an energy evolution equation using the parameters. The energy evolution equation includes an energy source term associated with a self-propagating front originating within the reactive multilayer material. The self-propagating front has a known speed and heat of reaction.

Still another embodiment of the invention includes a joint. The joint comprises a first component joined to a second component and remnants of a chemical transformation of a reactive multilayer material. The first component has a chemical composition different from the second component.

Various embodiments of the invention (e.g., any of the embodiments of the invention set forth above) may include one or more of the following aspects: the discretization of the energy evolution equation may be based on a finite-difference method, a finite-element method, a spectral-element method, or a collocation method; the reactive multilayer material may be a reactive multilayer foil and at least some of the parameters may be associated with the reactive multilayer material; the assembly may be a reactive joining configuration comprising a first component and a second component and at least some of the parameters may be associated with the first component and the second component; the reactive multilayer material may be disposed between the first component and the second component; the reactive joining configuration may further comprise a first joining layer and a second joining layer and at least some of the parameters may be associated with the first joining layer and the second joining layer; the reactive multilayer material may be disposed between the first joining layer and the second joining layer; the first joining layer and the second joining layer may be disposed between the first component and the second component; the first component and the second component may have substantially the same chemical composition; the first component and the second component may have different chemical compositions; the first component may comprise a metal, metal alloy, bulk-metallic glass, ceramic, composite, or polymer and the second component comprises a metal, metal alloy, bulk-metallic glass, ceramic, composite, or polymer; the metal or metal alloy may include one or more of aluminum, stainless steel, titanium, copper, Kovar, copper-molybdenum, molybdenum, iron, and nickel; the ceramic may include one or more of silicon carbide, aluminum nitride, silicon-nitride, silicon, carbon, boron, nitride, carbide, and aluminide; the first joining layer and the second joining layer may have substantially the same chemical composition; the first joining layer and the second joining layer may have different chemical compositions; the first joining layer may be one or more of solder and braze and the second joining layer may be one or more of solder and braze; the solder may be one or more of lead-tin, silver-tin, tin-bismuth, gold-tin, indium, indium-silver, indium-lead, lead, tin, zinc, gold, indium, silver, and antimony; the braze may be one or more of Incusil, Gapasil, TiCuNi, silver, titanium, copper, indium, nickel, and gold; the energy evolution equation including the energy source term may be

$$ρ \frac{\partial h}{\partial t} = ∇ \cdot q + \dot{Q} ,$$

wherein h is enthalpy, r is density, t is time, q is the heat flux vector, and \dot{Q} is the energy release rate in the reactive multilayer material; the parameters may include at least one of length, width, thickness, density, heat capacity, thermal conductivity, heat of fusion, melting temperature, heat of reaction, propagation velocity, atomic weight, and ignition location; determining the behavior of the energy distribution may include determining at least one of: an amount of melting of at least one of the first component and the second component; a duration of melting of at least one of the first component and the second component; whether critical interfaces have been wetted; an amount of thermal exposure of at least one of the first component and the second component; and a temperature, a peak temperature, a temperature profile, or temperature distribution of at least one of the first component, the second component, and the reactive multilayer material; determining the behavior of the energy distribution may include determining at least one of: an amount of melting of at least one of the first joining layer and the second joining layer; a duration of melting of at least one of the first joining layer and the second joining layer; whether critical interfaces have been wetted; an amount of thermal exposure of at least one of the first component and the second component; and a temperature, a peak temperature, a temperature profile, or temperature distribution of at least one of the first component, the second component, the first joining layer, the second joining layer, and the reactive multilayer material; the reactive joining configuration may further comprise a third joining layer and a fourth joining layer; each of the third joining layer and the fourth joining layer may be predeposited onto one of the reactive multilayer material, the first component, and the second component, and at least some of the parameters may be associated with the third joining layer and the fourth joining layer; the third joining layer and the fourth joining layer may have substantially the same chemical composition; the third joining layer and the fourth joining layer may have different chemical compositions; the third joining layer may be at least one of Incusil and Gapasil, and the fourth joining layer may be at least one of Incusil and Gapasil; selecting a first joining layer and a second joining layer for joining the first component to the second component using the reactive multilayer material; determining may include determining the behavior of the energy distribution in the first component, the second component, the first joining layer, the second joining layer, and the reactive multilayer material by integrating the discretized energy evolution equation using parameters associated with at least one of the first joining layer and the second joining layer; providing the first joining layer and the second joining layer having the parameters; positioning the first joining layer and the second joining layer between the first component and the second component; chemically transforming may cause a transformation of the first joining layer and the second joining layer; positioning the first joining layer and the second joining layer may include depositing one of the joining layers on one of the first component, the second component, and the reactive multilayer material; one of the joining layers may be a free-standing sheet; positioning may include positioning the free-standing sheet between the reactive multilayer material and one of the first component and the second component; selecting a third joining layer and a fourth joining layer for joining the first component to the second component using the reactive multilayer material; determining may include determining the behavior of the energy distribution in the first component, the second component, the first joining layer, the second joining layer, the third joining layer, the fourth joining layer, and the reactive multilayer material by integrating the discretized energy evolution equation using parameters associated with at least one of the third joining layer and the fourth joining layer; providing the third joining layer and the fourth joining layer having the parameters; predepositing each of the third joining layer and the fourth joining layer on at least one of the first component, the second component, and the reactive multilayer material; chemically transforming may cause a transformation of the third joining layer and the fourth joining layer; providing the parameters associated with a first joining layer and a second joining layer; determining may include determining the behavior of the energy distribution in the first component, the second component, the first joining layer, the second joining layer, and the reactive multilayer material by integrating the discretized energy evolution equation using parameters associated with at least one of the first joining layer and the second joining layer; providing the first joining layer and the second joining layer having the parameters; positioning the first joining layer and the second joining layer between the first component and the second component; chemically transforming may cause a transformation of the first joining layer and the second joining layer; a first joining layer and a second joining layer joining the first component to the second component; the parameters of at least one of the first component, the second component, the first joining layer, the second joining layer, and the reactive multilayer material may be predetermined based on the simulated behavior of the energy distribution within the first component, the second component, the first joining layer, the second joining layer, and the reactive multilayer material; the chemical transformation may be an ignition; a third joining layer and a fourth joining layer joining the first component to the second component; the parameters of at least one of the first component, the second component, the first joining layer, the second joining layer, the third joining layer, the fourth joining layer, and the reactive multilayer material is predetermined based on the simulated behavior of the energy distribution within the first component, the second component, the first joining layer, the second joining layer, the third joining layer, the fourth joining layer, and the reactive multilayer material.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts a schematic view of a reactive multilayer joining configuration;

FIG. 2(a) depicts a schematic view of a reactive multilayer joining configuration according to an embodiment of the invention;

FIG. 2(b) depicts a schematic view of a reactive multilayer joining configuration according to another embodiment of the invention;

FIG. 3(a) depicts a schematic view of a reactive multilayer joining configuration according to a further embodiment of the invention;

FIG. 3(b) depicts a schematic view of a reactive multilayer joining configuration according to yet another embodiment of the invention;

FIG. 4(a) depicts exemplary measured temperature profiles of the reactive multilayer joining configuration of FIG. 3a;

FIG. 4(b) depicts exemplary predicted temperature profiles of the reactive multilayer joining configuration of FIG. 3a;

FIG. 5(a) depicts predicted temperature profiles for an example of the reactive multilayer joining configuration of FIG. 3b;

FIG. 5(b) depicts measured and predicted temperature profiles for an example of the reactive multilayer joining configuration of FIG. 3b;

FIG. 6 depicts a schematic view of a reactive multilayer joining configuration according to a yet further embodiment of the invention;

FIG. 7(a) depicts an exemplary graphical display of a relationship between foil thickness and heat of reaction according to still another embodiment of the present invention;

FIG. 7(b) depicts, an exemplary graphical display of a relationship between foil thickness and front velocity according to a still further embodiment of the present invention;

FIG. 8 depicts exemplary graphical results for the reactive multiplayer joining configurations of FIG. 3(b) and FIG. 6;

FIG. 9 depicts exemplary graphical results for the reactive multiplayer joining configurations of FIG. 3(b) and FIG. 6;

FIG. 10 depicts a schematic view of a reactive multilayer joining configuration according to another embodiment of the invention;

FIG. 11(a) depicts exemplary predicted temperature profiles of the reactive multilayer joining configuration of FIG. 10;

FIG. 11(b) depicts an exemplary measured infrared temperature distribution of the reactive multilayer joining configuration of FIG. 10;

FIG. 11(c) depicts an exemplary measured infrared temperature distribution of the reactive multilayer joining configuration of FIG. 10;

FIG. 12 depicts exemplary graphical results for the reactive multilayer joining configuration of FIG. 10;

FIG. 13 depicts exemplary graphical results for the reactive multilayer joining configuration of FIG. 10;

FIG. 14 depicts exemplary graphical results for the reactive multilayer joining configuration of FIG. 10;

FIG. 15 depicts a schematic view of a reactive multilayer joining configuration according to a further embodiment of the invention;

FIG. 16 depicts exemplary graphical predictions for the reactive multilayer joining configuration of FIG. 15;

FIG. 17 depicts a schematic view of a reactive multilayer joining configuration according to yet another embodiment of the invention;

FIG. 18 depicts exemplary predicted temperature profiles of the reactive multilayer joining configuration of FIG. 15;

FIG. 19(a) depicts exemplary predicted results of the reactive multilayer joining configuration of FIG. 15;

FIG. 19(b) depicts exemplary predicted results of the reactive multilayer joining configuration of FIG. 15; and

FIG. 20 depicts a schematic view of a reactive multilayer joining configuration according to a yet further embodiment of the invention.

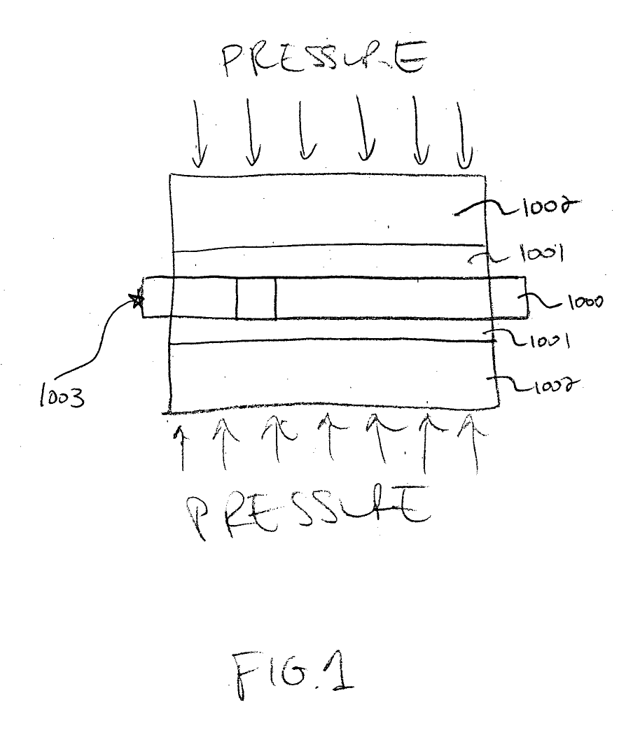

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Embodiments of the invention include a method for simulating a behavior of an energy distribution within an assembly containing a reactive multilayer material (e.g., foil or nanofoil), and/or applying this method to reactive joining arrangements.

In one embodiment of this invention, a computational model formulation in accordance with an aspect of the present invention is applied by discretizing (i.e., making mathematically discrete; defining for a finite or countable set of values; not continuous) an unsteady energy equation in a computational domain (e.g., including computational inputs and/or boundaries) that includes one or more properties of the reactive multilayer foil (e.g., nanofoil), the surrounding joining layers (e.g., solder and/or braze) and the components. In one example, this discretization is implemented by integrating the model equation set forth herein using as inputs various dimensions and physical properties of one or more of the reactive multilayer foil, the surrounding joining layers, and the components, as well as boundary conditions of the computational domain. One example includes a two-dimensional discretization in which the domains representing the foil, joining layers and the components are rectangular domains, each specified in terms of its length and thickness.

The embodiments below provide examples of such configurations, where a heat release rate \dot{Q} corresponds to an essentially flat self-propagating front traveling along the length of the reactive multilayer foil (e.g., the energy or heat wave front produced across one or more of the reactive multilayer foil, the surrounding joining layers, and the components when the reactive multilayer foil is ignited). For such implementation, inputs to the computational model include: (a) the dimensions (length and thickness) of the components, solder and/or braze layers, and the reactive foil, (b) the density, heat capacity, atomic weight, and thermal conductivity of the components, (c) the density, heat capacity, thermal conductivity, heat of fusion, atomic weight, and melting temperature of the solder and/or braze layers, (d) the heat of reaction and the propagation velocity, (e) the ignition location, (f) the density, heat capacity, thermal conductivity, heat of fusion, and melting temperature of the product of reaction in the reactive multilayer, and (g) thermal and mass flux conditions on domain boundaries. Computational solutions of the discretized model equations then provides the transient evolution of the thermal waves within the foil, the joining layers, and the components. Known discretization methods, numerical integration schemes, and methodologies for considering various two-dimensional and three-dimensional configurations, discretization and integration methods, ignition sources, as well as multi-dimensional front propagation can be implemented in connection with the present invention.

For example, application of the model may include providing the length, width, and thickness of each of a reactive multilayer foil (e.g., nanofoil), a first component, a second component, a first joining layer, and a second joining layer. Using these respective lengths, widths, and thicknesses as inputs, as well as thermal and mass flux conditions on domain boundaries, the equation set forth below is integrated for each of the reactive multilayer foil, the first component, the second component, the first joining layer, and the second joining layer. When integrated, the output is the prediction of a how an energy or thermal wave front will propagate in each of the reactive multilayer foil, the first component, the second component, the first joining layer, and the second joining layer when the reactive multilayer foil is ignited (e.g., chemically transformed). When the reaction is completed and the first component is joined to the second component, remnants (e.g., residue) of the reactive multiplayer foil may be present in one or more of first component, the second component, the first joining layer, and the second joining layer.

In another aspect of this invention, any of the aforementioned predictions of the computational model formulation (e.g., the prediction of how the energy or heat wavefront will behave in each of the reactive multilayer foil, the first component, the second component, the first joining layer, and the second joining layer) may be used to assess the magnitude and duration of various joining parameters such as melting of the solder and/or braze layers, the wetting of critical interfaces, and the thermal exposure of the components. The model can thus predict insufficient melting (e.g., transformation) of the solder and/or braze, lack of wetting at critical interface(s), excessively short melting duration, or excessive thermal exposure of the components, in which case the parameters of the reactive joining configuration can be systematically altered. The model can be reapplied to the altered configuration to verify whether the parameters are suitable. Examples include systematic variation of the thickness of the foil and the thicknesses of the solder and/or braze layers, the heat of reaction (for instance by altering the composition or microstructure), and/or the solder material. Such systematic variation of parameters can be iteratively applied until a suitable configuration is determined. It should be evident for someone skilled in the art how to generalize such an iterative approach to include other configuration parameters and iteration methods. For example, the inputs to the model may be any combination of any of the physical properties of any of the materials set forth herein.

Embodiments of the invention include a multi-dimensional computational code for simulating the reactive joining process. The code may be run and/or stored on a computer or any other suitable computer readable medium. The code may be an implementation of a multi-dimensional transient formulation of an energy equation that accounts for the properties of the self-propagating reaction as well as the physical properties of the reactive foil, the fusible materials, and/or the components. The computational model formulation consistent with the present invention will next be described.

The multi-dimensional model may be based on a specially-tailored mathematical formulation that combines an unsteady energy equation with a simplified description of the self-propagating reaction (e.g., reaction front) represented by \dot{Q} (e.g., energy source term):

$$ρ \frac{\partial h}{\partial t} = ∇ \cdot q + \dot{Q} \qquad ( 1 )$$

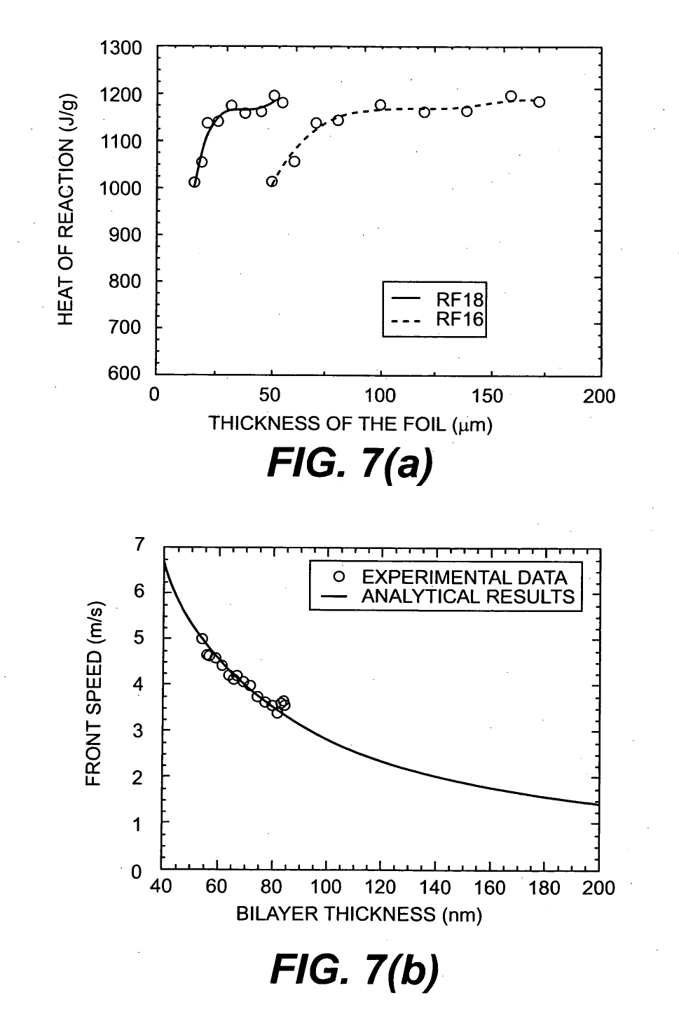

In Eq. (1), h denotes the enthalpy, ρ is the density, t is time, q is the heat flux vector, and \dot{Q} is the heat release rate. The enthalpy, h, is related to the temperature (e.g., as disclosed in Besnoin), T, through a detailed relationship that involves the material's heat capacity, c_{p,} and the latent heat, h_{f}. In particular, the term \dot{Q} represents the rate of heat released by the self-propagating front as it traverses the reactive foil. The latter is described in terms of a thin front that propagates in a direction normal to its surface. The propagation speed is prescribed using either measured (e.g., as disclosed in Gavens) or computed (e.g., as disclosed in Besnoin) values. Examples of the measured and computed propagation speeds is shown in FIG. 7(b), discussed in greater detail below. The strength of \dot{Q} is thus obtained by combining the known reaction velocity and heat of reaction for a given reactive foil. Note that \dot{Q} is localized within the front that traverses the foil, and vanishes within the one or more fusible materials and/or components.

The propagation of the heat or energy wave (e.g., evolution of the temperature) within the configuration, as well as the evolution of the melting and/or solidification of the one or more fusible materials, may be determined by integrating Eq. (1) over the entire configuration. A transient finite-difference computational model of the above formulation has been developed for this purpose. The finite-difference discretization is based on dividing the domain into computational cells of fixed grid size. Enthalpy is defined at cell centers, while fluxes are defined at cell edges. Second-order centered-difference approximations are used to approximate spatial derivatives. This spatial discretization scheme results in a finite set of coupled ordinary differential equations (ODEs) that govern the evolution of the enthalpy at the cell centers. The set of ODEs is integrated in time using an algorithm known as an explicit, third-order Adams Bashforth scheme. Based on the resulting solution, one can readily determine various properties of the reactive joining process, including the amount of solder that melts (e.g., transforms) at a specific cross-section or spatial location, the corresponding melting duration, as well as the temperature evolution within the foil, solder or braze layers, and the components. Various alternative spatial discretizations of arbitrary order, including as finite-element, spectral-element, or collocation approximations, as well as various implicit, explicit, or semi-implicit time-integration schemes can be. implemented.

In the case of a one-dimensional (or flat) reaction front, an equivalent steady formulation of Eq. (1) may be derived by recasting the equations of motion in a moving reference system that travels at the same speed as the reaction front. This alternative formulation, however, may have several drawbacks, including difficulties in specifying the variation of the thermal interface resistance with temperature (e.g., pre-reaction and/or post-reaction), in post-processing and data analysis (e.g., duration of melting), and in comparison with experimental measurements. Also note that when the interfaces between adjacent layers are not initially bonded, the formulation may accommodate a thermal interface resistance, and a variation of the thermal interface resistance may be observed as melting occurs along these interfaces.

In another example, embodiments of the invention may include using simulation results in order to determine the degree of melting (e.g., transforming) of the fusible materials (e.g., joining materials) that occurs within the reactive joining process, as well as the time duration over which wetting occurs at critical interfaces. As used in this application, a critical interface is an interface that requires wetting in order to form a suitable bond at the interface. In most cases, a critical interface is one that is initially unbonded. The critical interfaces in arrangements may vary depending on the parts (e.g., reactive foils, fusible materials, and/or components) and the configuration of the parts in the particular arrangement.

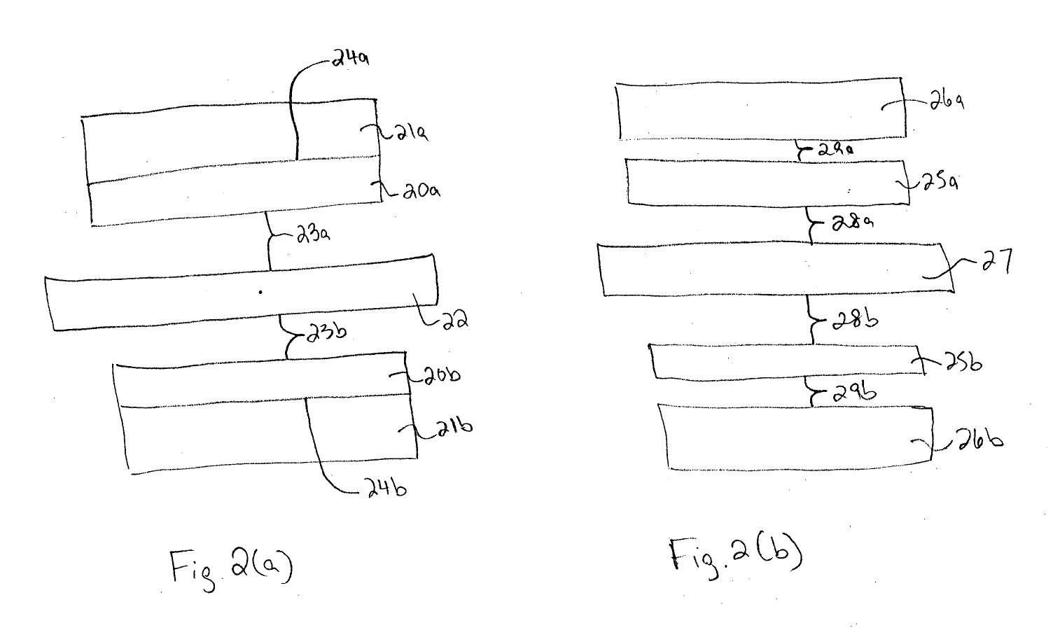

FIGS. 2(a) and 2(b) depict results from implementation of variations of the models set forth above and experiments. As shown in FIG. 2(a), one or more fusible materials 20a, 20b may be pre-deposited onto one or more components 21a, 21b so that a suitable bond may be provided, prior to chemical transformation (e.g., ignition) of the foil 22, between the one or more fusible material 20a, 20b and the one or more components 21a, 21b. Thus, critical interfaces in FIG. 2(a) are at the interfaces 23a, 23b between the foil 22 and the fusible materials 20a, 20b, and not at the interfaces 24a, 24b between the fusible materials 20a, 20b and the components 21a, 21b. For this arrangement, suitable parts (e.g., reactive foils, fusible materials, and/or components) may be selected (e.g., taking into consideration size, shape, and/or composition) and/or particularly positioned such that, when the reactive foil 22 is chemically transformed (e.g., ignited), the heat from the ignited reactive foil 22 may cause only a portion of the layers of the fusible material 20a, 20b to melt. In other words, the heat from the ignited reactive foil 22 may not effect a complete melting of the fusible material 20a, 20b and/or may not effect a melting the portion of the fusible material 20a, 20b that is bonded to its respective component 21a, 21b. In this arrangement, the melting of all of the fusible material 20a, 20b and/or melting of the fusible material 20a, 20b that is bonded to the component 21a, 21b may be undesirable for several reasons. First, to generate enough heat to completely melt the fusible material 20a, 20b, a thicker and/or more energetic foil 22 (e.g., having a more powerful chemical composition) may be necessary, which may unnecessarily increase the cost of the procedure. Second, melting the fusible material 20a, 20b that may be bonded to the component 21a, 21b may weaken the pre-existing strong bond at the interfaces 24a, 24b between the fusible materials 20a, 20b and the components 21a, 21b.

In FIG. 2(b), free-standing sheets of the fusible material 25a, 25b are disposed between the components 26a, 26b and the reactive foil 27. In this case, both interfaces of the fusible material 25a, 25b are initially unbonded and, thus, both interfaces 28a, 28b, 29a, 29b of the fusible material 25a, 25b (e.g., the interface 28a, 28b adjacent the reactive foil 27 and/or the interface 29a, 29b adjacent the component 26a, 26b) may be considered critical interfaces 28a, 28b, 29a, 29b. Accordingly, for this arrangement, suitable parts (e.g., one or more reactive foils 27, fusible materials 25a, 25b, and/or components 26a, 26b) may be selected (e.g., taking into consideration size, shape, and/or composition) and/or particularly positioned such that, when the reactive foil 27 is ignited, the heat from the ignited reactive foil 27 may cause a substantially complete melting of the one or more fusible materials 25a, 25b.

It is understood that the arrangements set forth in FIGS. 2(a) and 2(b) are not limiting, and that some of the aspects set forth herein may be combined, removed, altered, and/or used to implement any number of suitable arrangements and/or manufacture any number of suitable products. Based on the arrangements, what constitutes a critical interface that needs to be wetted may also vary. For example, one or more component surfaces may be untreated, or they may have a treatment layer (e.g., an adhesion underlayer of Ni and/or Au plating, a layer of a solder or braze, or both, for example, such that the layer of solder or braze is deposited onto the adhesion layer). In another example, a free-standing sheet of a fusible material may be disposed between the foil and each of the components, however, the free-standing sheet may or may not be used. In a further example, the reactive multilayer foil may have one or more fusible layers on one or more sides of the reactive multilayer foil. In yet another example, one or more layers of a fusible material may be provided between one or more reactive multilayers and one or more components. In a yet further example, one or more reactive multilayers maybe disposed between one or more components. In such a configuration, the one or more reactive multilayers may be in direct contact with the one or more components (e.g., a particular reactive foil may provide sufficient energy to effect melting of one or more components). Such a process may be called reactive welding, as opposed to reactive soldering or brazing. An example of reactive welding is disclosed in U.S. patent application Ser. No. 09/846,486 filed May 1, 2001 and entitled “Free Standing Reactive Multilayer Foils,” the entirety of which is incorporated herein by reference.

In a further example, embodiments of the invention may include combining simulation results with experimental observations to determine a suitable range of conditions that can be implemented in a reactive joining method to yield a reactive joint with suitable joint properties.

Embodiments of the invention may include any configuration and combination of any of the aspects set forth herein with respect to implementing and/or manufacturing suitable reactive joints using suitable reactive joining methods. One set of embodiments may include configurations where parts (e.g., one or more reactive foils, fusible materials, and/or components) are disposed substantially symmetrically about a reactive foil centerline. Another set of embodiments may include configurations where parts are disposed asymmetrically about a reactive foil centerline. These and other embodiments are described below.

For embodiments with symmetric configurations, the thermo-physical properties of any part at corresponding symmetrical locations on either side of the foil centerline may be substantially identical. An example may be reactive joining of components made of substantially the same material and/or using substantially identical layers of the fusible material. For embodiments with asymmetric configurations, material properties may differ at corresponding symmetric locations on either side of the foil. An example may include the joining of components made of dissimilar materials and/or reactive joining configurations that use different braze or solder layers on each side of the reactive foil. As reflected in the model results and experimental observations disclosed herein, one of the distinctive features of the two setups may be that for symmetric configurations heat may be transported symmetrically with respect to the foil centerline; a symmetric temperature distribution may accordingly prevail. In asymmetric configurations, the heat of reaction may be unequally transported with respect to foil centerline, and an asymmetric temperature field may be consequently established. As further disclosed herein, these features may have an impact on thermal transport during reactive joining, and suggest new joining arrangements and configurations.

The invention described herein has been applied to analyze a wide variety of symmetric configurations, in particular for reactive joining of Cu components, Au-plated stainless steel (SS) components, Ti components, as well as gold-plated Al. Exemplary results obtained for Cu—Cu joints and for the joining of Au-plated stainless steel to itself and for Au-plated Al to itself are provided herein. The methods and results for the Cu—Cu joints and SS-SS joints are also applicable to other materials (e.g., one or more of metal, metal alloy, bulk-metallic glass, ceramic, composite, polymer, aluminum, stainless steel, titanium, copper, Kovar, copper-molybdenum, molybdenum, iron, nickel, silicon carbide, aluminum nitride, silicon-nitride, silicon, carbon, boron, nitride, carbide, and aluminide).

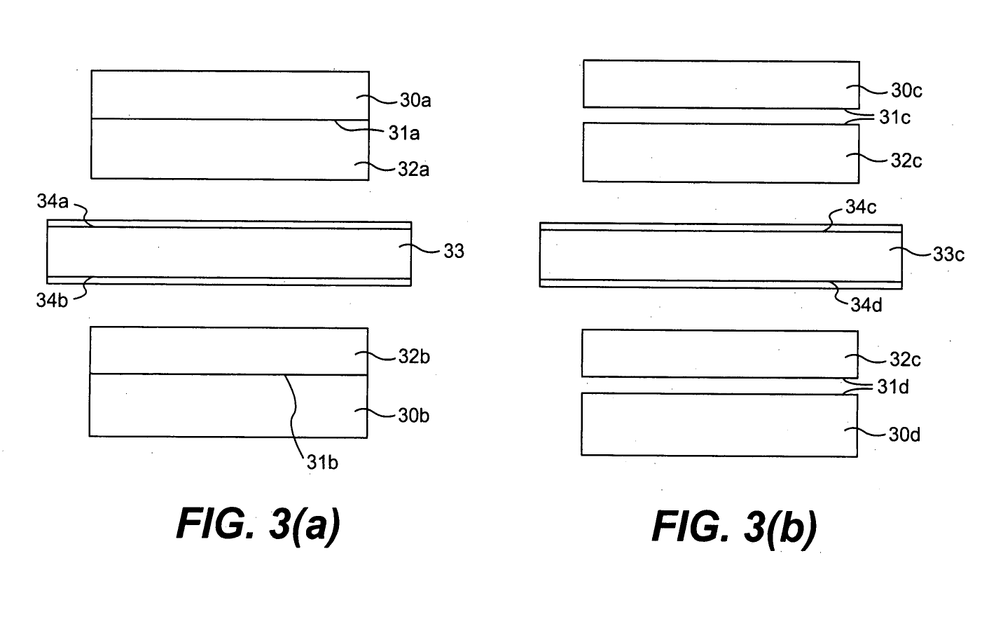

In one embodiment of the invention, the design model is validated by comparing computed predictions to temperature measurements performed during the reaction using infrared (IR) thermometry. Results are provided for the two configurations shown in FIGS. 3(a) and 3(b), showing reactive joining of two Cu components 30a, 30b in FIG. 3(a) and two Au-plated stainless steel components 30c, 30d in FIG. 3(b). As shown in FIG. 3(a), the surfaces 31a, 31b of the components 30a, 30b may be pre-wet with an Ag—Sn solder layer 32a, 32b having a thickness of approximately 75 μm. The free-standing Ni—Al foil 33 may have a thickness of about 55 μm, and each side of the foil 33 may have about 1 μm of Incusil 34a, 34b deposited thereon. As shown in FIG. 3(b), free-standing sheets of Au—Sn solder 32c, 32d may have a thickness of about 25 μm and may be disposed between the reactive foil 33c and the respective Au-plated stainless steel components 30c, 30d. The free-standing Ni—Al foil 33c may have a thickness of about 70 μm, and each side of the foil 33c may have about 1 μm of Incusil 34c, 34d deposited thereon. The materials and/or values disclosed herein are exemplary only. The present invention is applicable to other materials and/or dimensions (e.g., each joining layer and/or free-standing sheet may be one or more of lead-tin, silver-tin, tin-bismuth, gold-tin, indium, indium-silver, indium-lead, lead, tin, zinc, gold, indium, silver, antimony, Incusil, Gapasil, TiCuNi, titanium, copper, and nickel).

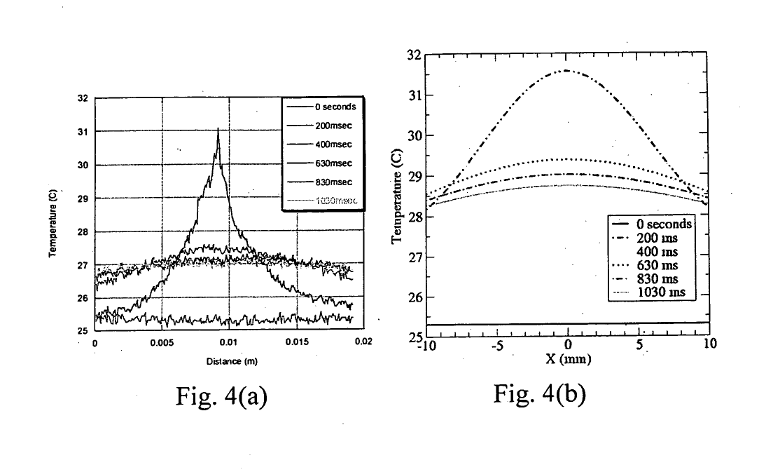

FIGS. 4(a) and 4(b) contrasts measured and predicted temperature profiles for the Cu—Cu joint configuration shown in FIG. 3(a). FIG. 4(a) illustrates the measured instantaneous temperature profiles at various times following ignition (e.g., chemical transformation) of the reactive multiplayer foil and at substantially constant positions on the Cu—Cu joint configuration during reactive joining of the Cu components. FIG. 4(b) discloses the predicted temperature profile (e.g., energy distribution) at substantially the same constant positions on the Cu—Cu joint configuration during reactive joining of the Cu components, taken here at 0 seconds, 200 milliseconds, 400 milliseconds, 630 milliseconds, 830 milliseconds, and 1030 milliseconds after ignition of the reactive multilayer foil. Note the close agreement between the measured and computed peak temperatures. Also note the short duration of the reactive joining process. As can be seen in FIGS. 4(a) and 4(b), the reactive joining process is essentially complete within hundreds of milliseconds of the passage of the front (e.g., the passage of the heat or energy, usually at its peak magnitude, through various positions on one or more of the reactive multilayer foil, the joining layers, and the components).

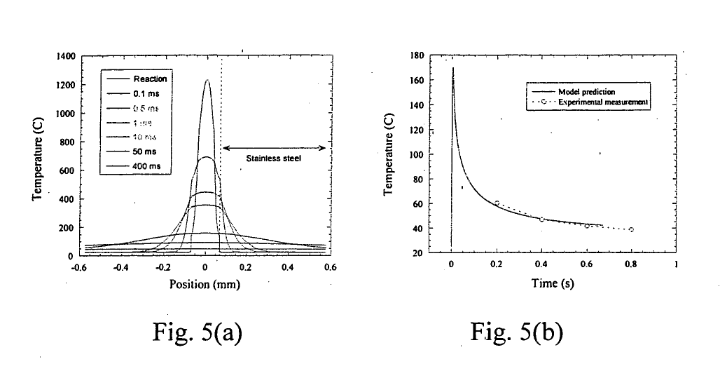

FIG. 5(a) shows predicted temperature profiles (e.g., energy distributions) across the stainless steel joint configuration shown in FIG. 3(b). Curves are generated at the selected time instants, corresponding to the moment of passage of the self-propagating front, and at 0.1 ms, 0.5 ms, 1 ms, 10 ms, 50 ms and 400 ms afterwards. The results show that the temperature across the joint decreases very quickly to 48° C. at 400 ms after the passage of the front, which is comparable with the experimental temperature measurement of 47° C. FIG. 5(b) shows the evolution of the temperature in the stainless steel configuration shown in FIG. 3(b) at 100 microns from the interface between the solder layer and the stainless steel. Shown are results (e.g., energy distributions) obtained from both the numerical simulations (predictions) and the infrared (actual) measurements. FIGS. 5(a) and 5(b) demonstrate substantial agreement between model predictions and experimental measurements, and show rapid drop of the temperature, and limited thermal exposure of the components.

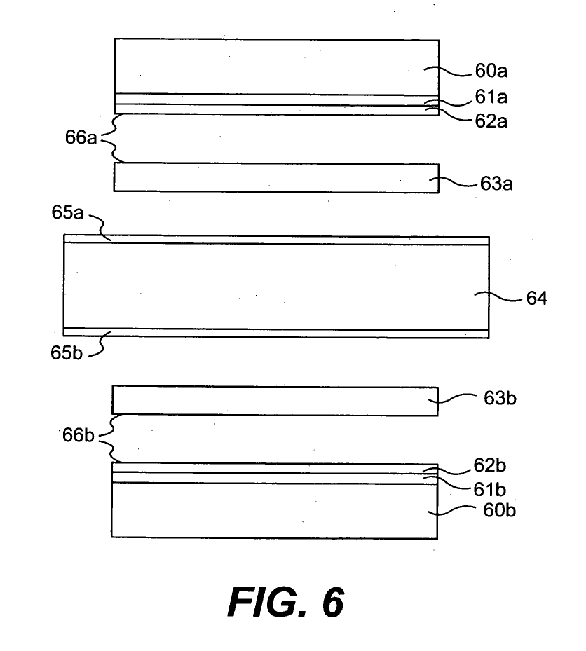

The model may be applied to systematically investigate the effect of the foil thickness on the wetting of critical interfaces, on the melting of the fusible material, and/or on the thermal exposure of the components. For example, FIG. 6 depicts an embodiment for the reactive joining of Al-6061T6 components 60a, 60b that may be first coated with a thin Ni underlayer 61a, 61b, and then an Au layer 62a, 62b. As shown in FIG. 6, free-standing sheets of Au—Sn solder may have a thickness of about 25 μm and may be used as the fusible material 63a, 63b. Each side of the foil 64 may have about 1 μm of Incusil 65a, 65b deposited thereon. The effect of the thickness of the foil 64 on the wetting of the critical interface 66a, 66b between the solder 63a, 63b and the component 60a, 60b (may or may not include one or more of layers 61a, 61b, 62a, 62b) may be analyzed by quantifying the time duration during which the solder 63a, 63b is locally in a molten state. To this end, the thickness of foil 64 may be systematically varied, while other parameters (e.g., of the foil 64, layers 61a, 61b, 62a, 62b, 65a, 65b, and/or fusible material 63a, 63b) may be fixed.

As described herein, the model inputs into the computation model formulation may include the thermophysical properties of the foil and of the components. For example, the table below discloses possible inputs such as the thermal conductivity, heat capacity, and/or density of Al-6061-T6, Au—Sn, Incusil-ABA, Al—NiV Foil, and/or stainless steel.

| | Thermal Conductivity | Heat Capacity | Density |
|---|---|---|---|
| Material | (W/m/K) | (J/kg/K) | (kg/m³) |
| Al-6061-T6 | 167 | 896 | 2700 |
| AuSn | 57 | 170 | 14510 |
| Incusil-ABA | 70 | 276 | 9700 |
| Al-NiV Foil | 152 | 830 | 5665 |
| Stainless Steel | 18 | 500 | 7990 |

Other possible inputs may include the solidus temperature of Incusil (Tₛ=878K), the liquidus temperature of Incusil (T_{I}=988K), the heat of fusion Incusil (H_{f}=10792 J/mol), the solidus temperature of Au—Sn solder (Tₛ=553K), the liquidus temperature of Au—Sn solder (T_{I}=553K), and/or the heat of fusion of Au—Sn solder (H_{f}=6188 J/mol).

Both predicted and measured values based on foil bilayer thickness are depicted in FIGS. 7(a) and 7(b). FIG. 7(a) shows how the heat of reaction may be affected by Al—Ni foil thickness for “thick” foils (e.g., RF16 having about 2000 bilayers) and “thin” foils (e.g., RF18 having about 640 bilayers). The lines depict the predicted heat of reaction given a particular bilayer thickness of the Al—Ni foil while the circles depict the measured heat of reaction of bilayers having a particular thickness. Note that the predicted heat of reactions substantially correlate with the measured heat of reactions. In a further example, FIG. 7(b) depicts how front velocity (speed) is dependent on bilayer thickness. The line shown in FIG. 7(b) depicts the predicted front velocity given a particular bilayer thickness of the Al—Ni foil while the circles depict the measured front velocity of bilayers having a particular thickness (e.g., as disclosed in Gavens and Besnoin). Note that the predicted front velocities substantially correlate with the measured front velocities.

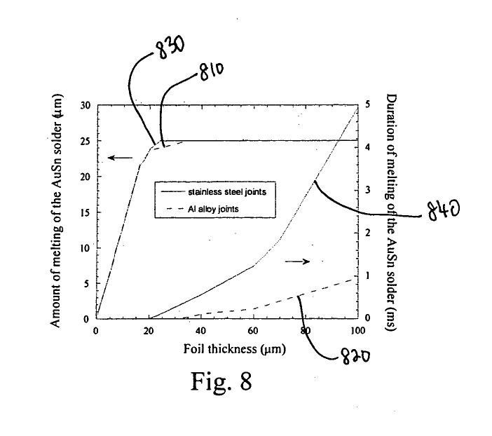

FIG. 8 depicts computed predictions for the amount of melting of the solder layer as well as the duration of melting at the critical solder-component interface as a function of foil thickness (e.g., energy distribution). The dashed lines 810, 820 represents results that may be obtained for reactive joining of Al—Al components, for example, as shown in the configuration depicted in FIG. 3(b), while the solid lines 830, 840 represents results that may be obtained for reactive joining of Au-plated stainless steel components, for example, as shown in the configuration depicted in FIG. 6.

For Al—Al joints, the model predictions in FIG. 8 indicate that when the foil thickness is smaller than about 35 μm, only partial melting of the about 25 μm-thick layers of Au—Sn solder may occur. Accordingly, the duration of melting at the critical interface between the solder and the component may be about 0 ms. On the other hand, when a foil having a thickness substantially equal to or greater than about 35 μm is used, the entire solder layer may melt and the duration of wetting of the critical interface (e.g., duration of melting of the Au—Sn solder layer locally at the interface) may be positive. In particular, the duration of melting may increase as the foil thickness increases. The model prediction also indicates that the minimum foil thickness needed to melt the about 25 μm-thick layer of Au—Sn solder may be larger for the Al—Al joints than for the SS-SS joints. Furthermore, for corresponding foil thicknesses (e.g., greater than about 20 μm), the model predicts that the duration of melting of the solder layer may be larger (and as the foil thickness increases, substantially larger) for the SS-SS joints than for the Al—Al joints. This may be due to the fact that the thermal conductivity of stainless steel may be much smaller than that of Al-6061-T6. Consequently, heat may be conducted at a much slower rate into the SS than in the Al. These predicted results underscore the need for a careful optimization of the design, configuration, and/or dimensions of reactive joining configurations (e.g., foil thickness), based on the properties of the self-propagating reaction and the thermophysical properties of the reactive multilayer, of the fusible materials, and/or of the components.

In another embodiment of the invention, additional numerical predictions of the model (e.g., associated with the melting of the fusible material and/or of wetting of critical interfaces) may be contrasted with additional experimental measurements, for example, the shear strength of the reactive joints.

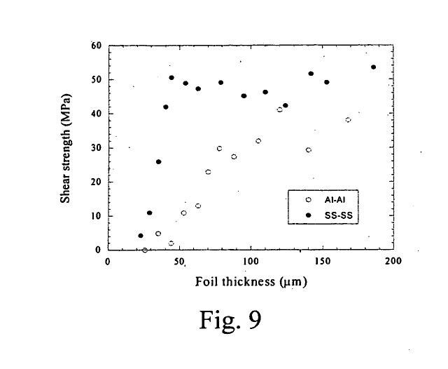

For example, FIG. 9 shows that the measured shear strength of the Al—Al joints and/or SS-SS joints may be associated with and/or dependent on foil thickness. In particular, the foils that are thicker than about 55 μm correspond to the RF16 family (e.g., have about 2000 bilayers), while the foils that are thinner than about 55 μm correspond to the RF18 family (e.g., having about 640 bilayers). The joint strengths were measured using tensile shear-lap tests. Consistent with the predictions set forth in FIG. 8, the measurements of FIG. 9 indicate that successful joints may be obtained when the thickness of the reactive foil for an Al—Al joint is about 35 μm, and when the thickness of the reactive foil for a SS-SS joint is about 20 μm. Specifically, FIG. 9 shows that Al—Al joints may fail when the reactive foil is thinner than about 35 μm and/or that SS-SS joints may fail when the foil thickness is less than about 20 μm. The measurements set forth in FIG. 9 also show that the respective joint strengths may steadily increase with increases in the thicknesses of the respective foils until a plateau and/or peak strength is reached. Once that peak and/or plateau is reached, the joint strength may remain constant and/or no further strength may be imparted to the joint even with successive increases in foil thickness. For SS-SS joints, the plateau may be reached when the foil is thicker than about 42 μm, and for Al—Al joints, the peak strength may be reached when the foil is about 80 μm thick.

Accordingly, by using the model predictions of FIG. 8 and the measured results of FIG. 9, one may be able to correlate the optimal and/or maximum strength of a particular joint with the time duration during which the solder remains in a molten state at the critical interface. For example, for the present configurations, one may be able to conclude that the Au—Sn solder must wet the critical interface for about 0.5 ms in order to achieve an optimal and/or maximum strength bond. The bond strength may also be affected by other parameters of the present configurations, for example, the peak temperature at the interface between the fusible material and the component. The predictions and/or corresponding measurements set forth herein hold for both the Al—Al and SS-SS joints. It should be evident for someone skilled in the art how to generalize the present embodiment to a variety of other material systems.

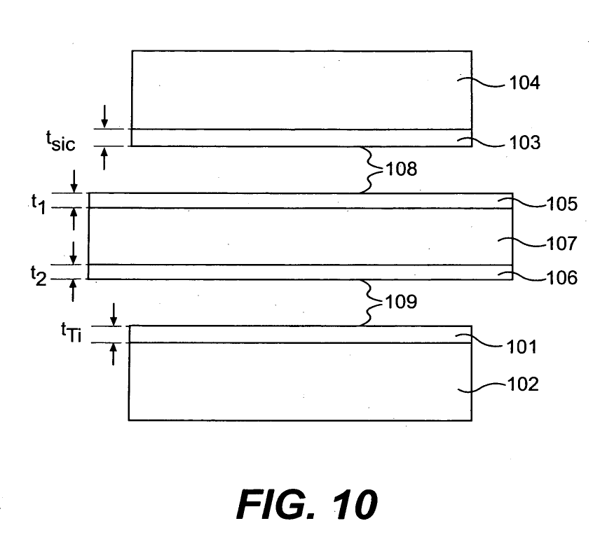

In another embodiment of this invention, the design approach set forth herein may be applied to analyze asymmetric configurations (i.e., configurations where properties of the materials, such as thermal properties, may differ on different sides of the foil). An example of such an asymmetric configuration is shown in FIG. 10, which illustrates the reactive joining of SiC to Ti-6-4, in which the thicknesses of the Incusil layers that are pre-deposited onto the SiC and Ti may be held fixed.

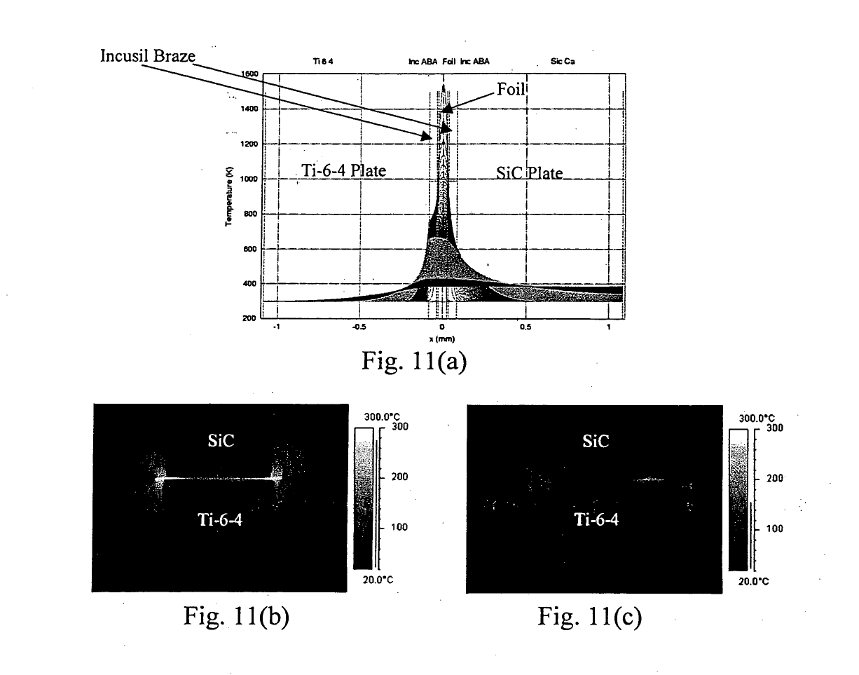

As SiC may have a much larger thermal conductivity than Ti-6-4, the thermal profile during the reactive joining may be asymmetric with respect to the foil centerline. Such asymmetry in the thermal profile of across the SiC and Ti-6-4 assembly is shown in FIG. 11(a), which graphically shows that the thermal wave may diffuse faster on the SiC side than on the Ti. Moreover, the peak temperatures may be generally higher on the Ti side than on the SiC side. Similar effects (e.g., faster diffusing on the SiC side than on the Ti side and/or higher peak temperature on the Ti side than on the SiC side) may be observed by analysis of IR thermometry images of the SiC—Ti assembly during reactive joining, exemplary samples of are shown in FIGS. 11(b) and 11(c). FIG. 11(b) shows an IR image of the configuration at the ignition of the reactive multilayer foil, while FIG. 11(c) shows an IR image of the configuration at about 240 ms after ignition. As further discussed herein, this understanding of the thermal properties of an asymmetric joining configuration may be used to design new reactive joining configurations.

Returning to FIG. 10, the thickness of an Incusil layer 101 that may be pre-deposited onto the Ti 102 may be about 62 μm thick, while the Incusil layer 103 that is pre-deposited onto the SiC 104 may be about 100 μm thick. In this particular design analysis, as set forth below, a parametric study may first be conducted of the effect of the thicknesses of the braze layers 105, 106 pre-deposited on both sides of the reactive foil 107. To this end, the thicknesses of the braze layers 105, 106 facing the SiC (t₁ in FIG. 10) and Ti (t₂ in FIG. 10) may be varied independently. Meanwhile, the overall thickness (180 μm), reaction heat (1189 J/g) and reaction velocity (2.9 m/s) of the foil 107 and the thicknesses of the adjoining layers 105, 106 may be held fixed. The foils used in the analysis of SiC/Ti-6-4 joints may correspond to the RF16 family, whose properties are shown in FIGS. 7(a) and 7(b). Other inputs to the design model are provided in the table below.

| | Thermal Conductivity | Heat Capacity | Density |
|---|---|---|---|
| Material | (W/m/K) | (J/kg/K) | (kg/m³) |
| SiC | 130 | 750 | 3200 |
| Ti-6-4 | 6.7 | 610 | 4510 |
| Incusil-ABA | 70 | 276 | 9700 |
| Ni/Al Foil | 152 | 830 | 5665 |

Other possible inputs may include the solidus temperature in Incusil (Tₛ=878K), the liquidus temperature of Incusil (T_{I}=988K), and the heat of fusion of Incusil (H_{f}=10,792 J/mol).

The model computations for FIG. 10 are focused on the wetting of the critical interfaces, which in the present case correspond to the interfaces 108, 109 between the Incusil layers 105, 106 pre-deposited onto the foil 107 and the Incusil layers 101, 103 pre-deposited onto their respective components 102, 104. Specifically, for the arrangement shown in FIG. 10, the reaction may be required to produce sufficient heat so as to melt the braze layers 105, 106 that are pre-deposited onto the foil 107, as well as partially melt the braze layers 101, 103 that are pre-deposited onto the Ti 102 and the SiC 104. In the computations, we quantify this phenomenon (e.g., melting of the one or more braze layers) by monitoring the peak thicknesses of the molten braze layers 101, 103 on the SiC 104 and Ti 102, respectively t_{SiC} and t_{Ti}. The following table shows the various thicknesses t_{SiC}, t_{Ti} of molten braze layers 103, 101 (i.e., amount of melting of the braze) for various combinations of the thicknesses t₁, t₂ of the one or more braze layers 105, 106 pre-deposited on the foil 107.

| t₁ (μm) | t₂ (μm) | t_{SiC} (μm) | t_{Ti} (μm) |
|---|---|---|---|
| 1 | 1 | 19.32 | 45.95 |
| 1 | 4 | 19.36 | 35.05 |
| 1 | 8 | 19.40 | 27.03 |
| 1 | 12 | 19.44 | 19.87 |
| 1 | 16 | 19.48 | 13.84 |
| 4 | 1 | 15.49 | 47.54 |
| 4 | 4 | 15.54 | 35.39 |
| 4 | 8 | 15.57 | 27.24 |
| 4 | 12 | 15.62 | 21.03 |
| 4 | 16 | 15.66 | 13.99 |
| 8 | 1 | 11.50 | 47.95 |
| 8 | 4 | 11.55 | 35.63 |
| 8 | 8 | 11.58 | 27.38 |
| 8 | 12 | 11.62 | 21.15 |
| 8 | 16 | 11.67 | 15.11 |
| 12 | 1 | 7.74 | 49.55 |
| 12 | 4 | 7.79 | 35.98 |
| 12 | 8 | 7.82 | 27.58 |
| 12 | 12 | 7.87 | 21.31 |
| 12 | 16 | 7.92 | 15.26 |
| 16 | 1 | 3.75 | 51.31 |
| 16 | 4 | 3.79 | 37.45 |
| 16 | 8 | 3.82 | 27.83 |
| 16 | 12 | 3.87 | 21.51 |
| 16 | 16 | 3.92 | 15.45 |

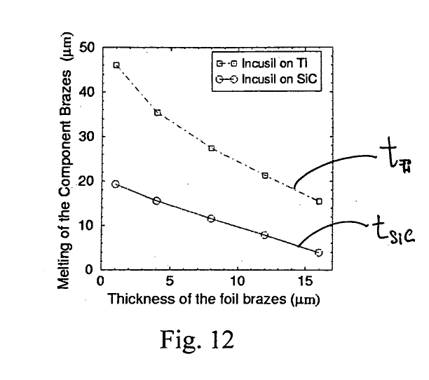

FIG. 12 graphically shows the thickness of the molten braze layer 101, 103 as a function of the one or more braze layers 105, 106 deposited on either side of the reactive foil 107 for the combinations where an equal thickness of braze 105, 106 is deposited on either side of the reactive foil 107 (i.e., t₁=t₂). The dashed curve shows the amount of melting of the braze on Ti component and the solid curve shows the amount of melting of the brazeon he SiC component.

Examination of the results in the table above reveals that the amount or thickness t_{SiC} of braze 103 that melts on the SiC component 104 may depend on the thickness t₁ of the braze layer 105 on the SiC-side of the foil 107. Specifically, t_{SiC} may decrease as t₁ increases. Similarly, the amount or thickness t_{Ti} of braze 101 that melts on the Ti component 102 may depend on the thickness t₂ of the braze layer 106 on the Ti-side of the foil 107, and decrease as the latter increases. This effect is graphically depicted in FIG. 12; where both curves (t_{SiC} and t_{Ti}) decrease as one increases the thickness of the braze layer 105, 106 (e.g., having thickness of t₁ and t₂) that may be pre-deposited onto the foil 107. This figure also shows that more braze may melt on the Ti component than on the SiC component (t_{Ti}>t_{SiC}). This prediction may be attributed to the fact that SiC has a much higher thermal conductivity than Ti-6-4. Combined, the present results indicate it may be desirable to keep the thickness of braze 105, 106 pre-deposited onto the foil 107 as small as possible. The results also indicate that, for a foil 107 having a total thickness (not including the layers 105, 106) of about 180 μm having Incusil layers 105, 106 with a thickness of about 1 μm pre-deposited on both sides of the foil 107, substantial melting of the braze layers 101, 103 deposited onto both components 102, 104 may occur. Thus, this configuration provides a suitable design for the joining process. Based on these results, one may be able to design the thickness of the fusible material pre-deposited on the reactive nanofoil, both to design the joining process as well as to achieve other effects such as limiting the thermal exposure of the components.

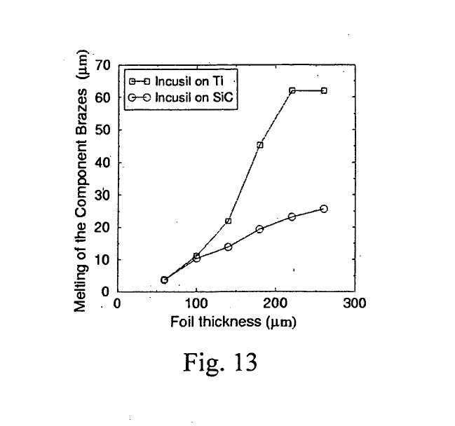

The asymmetric arrangement of FIG. 10 may also be used to examine the effect of overall foil thickness, t_{F}, on t_{Ti} (the thickness of the molten braze layer 101 on the titanium 102) and t_{SiC} (the thickness of the molten braze layer 103 on the silicon carbide 104). In light of the results above, the thicknesses t₁ (the thickness of the braze layer 105 on the SiC side of the foil 107) and t₂ (the thickness of the braze layer 106 on the Ti-side of the foil 107) may be held fixed, t₁=t₂, where, for example, both t₁ and t₂ may be equal to about 1 μm. As shown in FIG. 13, the foil thickness t_{F} was varied between about 60 μm and about 270 μm, and the computed values of t_{Ti} and t_{SiC} are plotted against t_{F}. The results show that each of t_{Ti} and t_{SiC} may increase as the foil thickness t_{F} increases. For foil thicknesses t_{F} smaller than about 100 μm, the amount of melting of the braze layers 101, 103 that are pre-deposited onto the components 102, 104 may be quite small, as t_{Ti} and t_{SiC} may both fall below about 10 μm. On the other hand, for a foil thickness t_{F} larger than about 200 μm, the entire layer of Incusil 101 pre-deposited onto the Ti 103 may melt. The present results thus indicate that, for the configuration of FIG. 10, a suitable and/or desirable foil thickness to achieve the suitable and/or desired effects may be in the range of about 150 μm to about 200 μm. A foil thickness between about 150 μm and about 200 μm may be suitable and/or desirable because such a foil thickness may ensure sufficient wetting of critical interfaces 108, 109 and/or avoid complete melting of the braze layers 101, 103 that are pre-deposited onto the components 102, 104. Using this methodology, the foil thickness can be designed so as to induce melting at critical interfaces 108, 109, while avoiding this effect at initially bonded interfaces.

The asymmetric arrangement of FIG. 10 may also be used to examine the effect of heat of reaction on the melting of the fusible material 101, 103, 105, 106 and on wetting at critical interfaces 108, 109. As mentioned herein, the heat of reaction of reactive multilayer foils may be controlled using a variety of means, for example, by varying one or more of the stoichiometry, the deposition rate (which affects the premix width), and/or the bilayer thickness, and/or by annealing the foil at moderate temperature in an inert environment, as discussed in Gavens and Glocker.

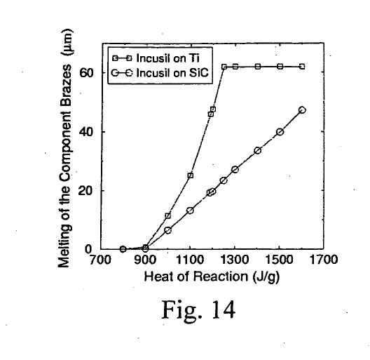

To illustrate the impact that varying the heat of reaction may have on melting fusible materials 101, 103, 105, 106 and/or wetting critical interfaces 108, 109, computer simulations were conducted with a foil 107 having a fixed thickness t_{F} of about 180 μm, and Incusil layers 105, 106, that were pre-deposited on the foil 107, each having a fixed thickness t₁ and t₂ of about 1 μm. The front velocity was held fixed at about 2.9 m/s. With these fixed values, the heat of reaction was varied in the range between about 800 J/g and about 1600 J/g. Using these inputs, predicted values for t_{Ti} and t_{SiC} were computed from the simulations and are plotted against the heat of reaction, as shown in FIG. 14. The results indicate that t_{Ti} and/or t_{SiC} may exhibit a strong dependence and/or correlation with the heat of reaction. For example, as shown in FIG. 14, when the heat of reaction drops below about 900 J/g, the results predict that insignificant melting of the braze layers 101, 103 may occur. As the heat of reaction is increases beyond about 900 J/g, the results predict that the curves for t_{Ti} and/or t_{SiC} may rise rapidly. In particular, when the heat of reaction exceeds about 1300 J/g, the results predict that substantially the entire layer of Incusil 101 pre-deposited onto the Ti 102 may melt during the reactive joining process. These results underscore the need and/or benefits of carefully controlling or characterizing the heat of reaction. For example, in the present asymmetric configuration set forth in FIG. 10, the heat of reaction used may preferably fall in the range of about 1100 J/g to about 1300 J/g. The heat of reaction can be controlled in a known manner so as to control the amount of melting of the braze material, to thereby limit the thermal exposure of the components, and/or to control other related results and/or effects.

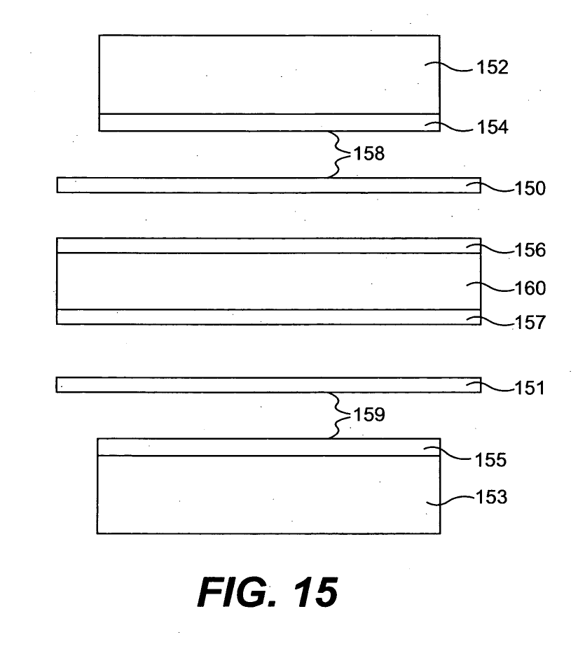

In another embodiment of this invention, one or more free-standing sheets 150, 151 of one or more fusible or joining materials (e.g., solder or braze) may be used in an asymmetric configuration. For example, FIG. 15 illustrates an alternative configuration for joining of SiC 152 and Ti 153. As illustrated in FIG. 15, free-standing sheets 150, 151 of Au—Sn solder as the fusible material. The sheets 150, 151 may each have a thickness of about 25 μm. The SiC 152 and Ti 153 may be treated in substantially the same fashion as any of the configurations set forth herein. For example, an Incusil layer 155 having a thickness of about 62 μm may be pre-deposited onto the Ti 153 and/or an Incusil layer 154 having a thickness of about 100 μm may be pre-deposited onto the SiC 152. The reactive foils 160 may have Incusil layers 156, 157 pre-deposited on either side. The Incusil layers 156, 157 pre-deposited on the reactive foils 160 may have a thickness of about 1 μm.

In the configuration shown in FIG. 15, the foil 160 may preferably deliver sufficient amounts of heat to completely melt the free-standing Au—Sn layers 150, 151. However, melting of one or more of the Incusil braze layers 154, 155, 156, 157 may not be necessary, as each Au—Sn solder layer 150, 151 may adhere sufficiently to its respective Incusil braze layers 154, 155, 156, 157 regardless of whether the braze itself melts. As discussed below, a parametric study was conducted to determine the effect that the thickness of the foil 160 has on the melting of the solder layers 150, 151 and/or the melting of the one or more Incusil braze layers 154, 155 that are pre-deposited onto the Ti 153 and SiC 154. The thickness of the reactive foil layer 160 was varied between about 30 μm and about 270 μm.

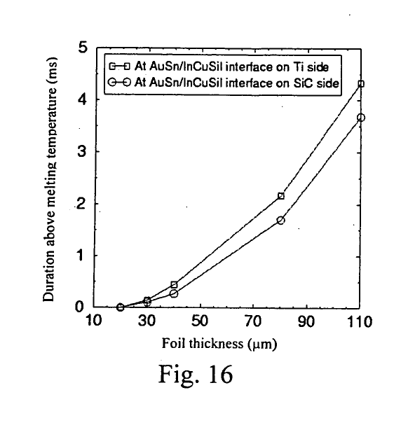

Since the present configuration may require substantially complete melting of the Au—Sn solder 150, 151, the predictive analysis was conducted by monitoring the solder temperature at the interface 158, 159 of each Au—Sn solder layer 150, 151 and its respective Incusil braze layers 154, 155 which are pre-deposited on the component Ti 153 and SiC 152. For each of the configurations (e.g., where the thickness of the reactive foil layer 160 was varied), time intervals were recorded during which the solder layers 150, 151 remained above their melting temperature locally at each of interfaces 158, 159. The predicted results are shown in FIG. 16, where the time interval during which solder layers 150, 151 remained above their melting temperature locally at each of the interfaces 158, 159 is plotted against the foil thickness. The predicted results demonstrate that a minimal foil thickness of about 30 μm may be necessary in order to melt both Au—Sn solder layers 150, 151 (e.g., the Au—Sn solder layer on the Ti side and/or the SiC side). For foils 160 having a thickness of less than about 30 μm, the model predicts that there may be only partial melting of one or more Au—Sn solder layers 150, 151, and therefore a lack of bonding between one or more of the Au—Sn solder layers 150, 151 and the one or more Incusil braze layers 154, 155.

The strength of reactively formed joints using Au—Sn solder was determined experimentally, examples of which are set forth herein, and the shear strength measurements were compared with computational predictions. The analyses set forth below reveal that the joint strength may initially increase as the duration of the melting of the Au—Sn solder increases, and that peak strengths of the joints may be obtained when the Au—Sn solder at the critical interfaces is above its melting temperature for a time duration exceeding about 0.5 ms. Based on this work, a foil thickness of about 70 μm may be needed to achieve an adequate joint strength. The computations were also used, examples of which are set forth herein, to examine possible melting of Incusil which is pre-deposited onto the components. The results indicate that when the foil thickness is smaller than about 200 μm, the braze layers pre-deposited onto the Ti and SiC may remain below the Incusil's melting temperature. For thicker foils, partial melting of the Incusil in one or both of these layers 154, 155 may occur.

In another embodiment of this invention, the effect of the melting duration of the solder or braze on the strength of the resulting reactive joints has been analyzed experimentally and modeled. The experimental investigation has been applied to configurations having different lengths and widths for one or more of the foil, solder layers, and components, but With fixed thicknesses for one or more of the foil, the solder layers, and of the components. Specifically, reactive joints between SiC and Ti-6-4 have been formed using Incusil (braze) as the fusible material, and using AgSnSb (solder) as the fusible material. Both small-area (0.5 in.×0.5 in.) and large-area (4 in.×4 in.) have been considered, and the strength of the resulting joints experimentally determined. In both cases, a 90 μm reactive foil was used. The measured strength of the joints is shown in the table below as function of the joint area:

Fusible Material

| Area | Incusil (braze) | AgSnSb (solder) |
|---|---|---|
| 0.5 in × 0.5 in | 59.5 MPa | 67.5 MPa |
| 4 in × 4 in | 0 MPa | 66.9 MPa |

In this instance, the model predictions indicate that, irrespective of the joint area, the melting duration of the Incusil braze is about 0.28 ms, while the AgSnSb solder melting duration is about 5.49 ms. The larger melting duration of the solder is in fact expected, since the latter has much lower melting temperature. Comparison of the prediction of melting duration with measured shear strength reveals that the larger the length and the width of the configuration (i.e. the joining area), the larger the melting duration needed to achieve adequate strength of the reactive joint. This is evidenced by the fact that with Incusil as the fusible material, the melting duration was short, and strong bonds were obtained for the small-area joint but the joints failed when the same protocol was applied to a large-area joint. On the other hand, with AgSnSb as the solder material, the melting duration was larger and similar strengths were obtained for both small-area and large-area joints. It should be evident for someone skilled in the art how to generalize these findings to other material systems and joint areas.

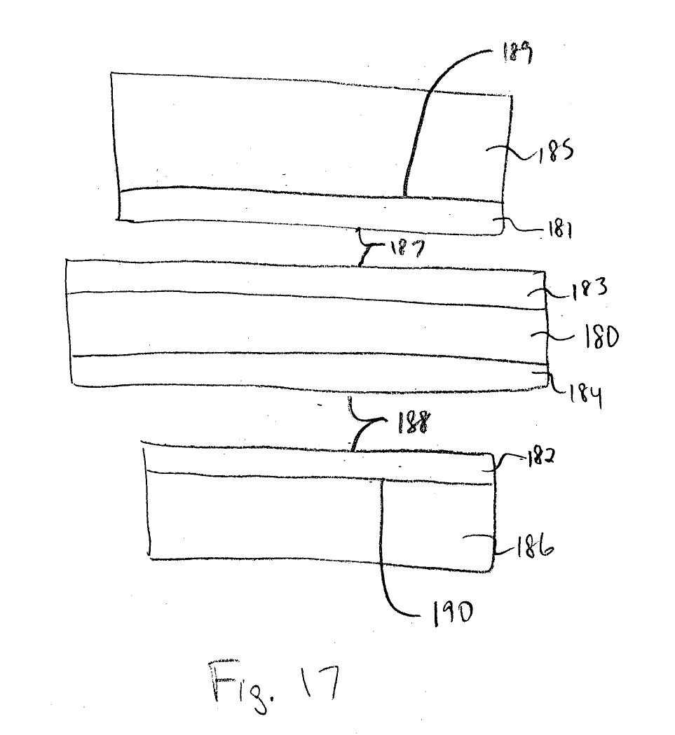

In an alternative embodiment of this invention, another asymmetric configuration corresponding to reactive joining of Al-6101-T6 to Al₂O₃ is considered in FIG. 17. In particular, the configuration in FIG. 17 may be used to analyze the effect of the thickness of the foil 180 on the wetting of the critical interface between the foil 180 and the solder 181, 182, namely by quantifying the time duration during which the solder 181, 182 is locally in a molten state. To this end, the thickness of the foil 180 may be systematically varied, while the remaining parameters may be held fixed. The model inputs include the thermophysical properties of the foil 180, the joining layers, 181, 182, 183, 184, and of the components 185, 186, as set forth in the following table and FIG. 7.

| | Thermal Conductivity | Heat Capacity | Density |
|---|---|---|---|
| Material | (W/m/K) | (J/kg/K) | (kg/m³) |
| Al-6101-T6 | 218 | 895 | 2700 |
| Ag-Sn | 33 | 227 | 7360 |
| Incusil-ABA | 70 | 276 | 9700 |
| Al-NiV Foil | 152 | 830 | 5665 |
| Al₂O₃ | 30 | 88 | 3900 |

Other possible inputs may include the solidus temperature in Incusil (Tₛ=878K), the liquidus temperature of Incusil (T_{I}=988K), the heat of fusion of Incusil (H_{f}=10,792 J/mol), the solidus temperature of Ag—Sn solder (Tₛ=494K), the liquidus temperature of the Ag—Sn solder (T_{I}=494K), and the heat of fusion of Ag—Sn solder (H_{f}=14200 J/mol).

In the configuration shown in FIG. 17, the solder layer 181 on the Al₂O₃ component 185 may have a thickness of about 100 μm, while the solder layer 182 on the Al-6101-T6 component 186 may have a thickness of about 75 μm. The reactive multilayer foil 180 may have about 1 μm thick layers 183, 184 of Incusil deposited on both sides of the foil 180.

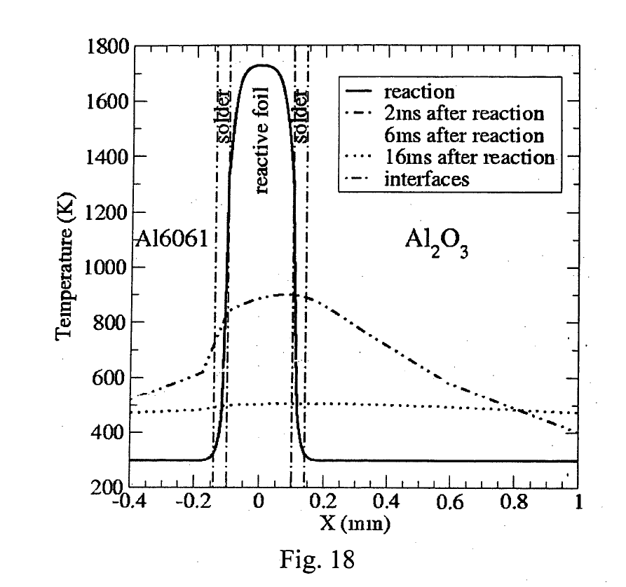

Details of the temperature distribution during the reactive joining process are shown in FIG. 18, which depicts instantaneous profiles across the joint due to the chemical transformation of a foil 180 having a thickness of about 148 μm at different times. As seen in FIG. 18, thermal transport may occur in an asymmetric fashion on either side of the foil 180, and that the thermal gradients in solder layers 181, 182 may be weaker on the side with the Al₂O₃ component 185 than on the side with the Al-6101-T6 component 186. These phenomena may be directly traced to the disparity between the components' 185, 186 thermal diffusivity, which may be much higher for the Al-6101-T6 component 186 than for the Al₂O₃ component 185.

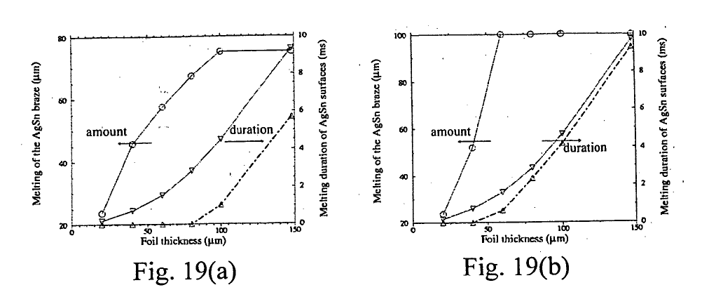

The effect of the thickness of the foil 180 is analyzed in FIGS. 19(a) and 19(b). FIG. 19(a) shows the amount of melting of the solder layers 181, 182 and FIG. 19(b) illustrates the duration of melting at the critical foil-solder interfaces 187, 188 and at the solder-component interfaces 189, 190. The predictions indicate that joining may occur for all the foil thicknesses considered, which range between about 20 μm and about 148 μm. Note that when the thickness of the foil 180 is less than about 60 μm, partial melting may occur in both solder layers 181, 182. For foil thicknesses between about 60 μm and about 100 μm, complete melting may occur of the solder layer 181 lying on the side of the Al₂O₃ component 185, while the solder layer 182 on the side of the Al-6101-T6 component 186 may partially melt. For foil 180 having a thickness larger than about 100 μm, both solder layers 181, 182 may completely melt. In the latter regime, the results indicate that the local melting duration of the solder layers 181, 182 may increase substantially linearly with increasing thickness of the foil 180. Consistent with the results in FIG. 18, FIGS. 19a and 19b also indicate that there may be more complete and uniform melting on the side of the Al₂O₃ component 185 than on the side of the Al-6101-T6 component 186. In particular, the duration of melting at the solder-foil interface 187 on the Al₂O₃ side may be approximately equal to the duration of melting at the solder-component interface 189 also on Al₂O₃ side, as shown in FIG. 19b. On the other hand, these melting durations may differ substantially on the Al side, as shown in interfaces 188, 190 in FIG. 19a. Combined, the results in FIGS. 18, 19a, and 19b demonstrate that the thermal diffusivity of the solder and the components may be critical to duration and uniformity of the melting, and hence to joint strength. Consequently, the design of reactive joining applications should carefully account for these parameters.

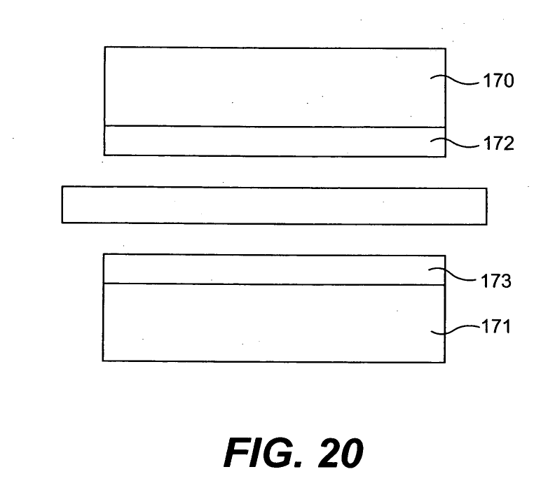

In another embodiment of this invention, a reactive joining configuration may be used that involves multiple fusible-material layers that are chemically distinct. One particular configuration is set forth in FIG. 20. FIG. 20 shows an asymmetric configuration in which two fusible materials 172, 173 are employed, where the fusible material 172 with higher melting temperature T1 may be used on the side with the component 170 having a lower thermal conductivity k1, while the fusible material 173 with lower melting temperature may be used on the side with the more conductive component 171 having a higher relative thermal conductivity k2. Examples of such arrangement include the joining of SiC and Ti, where a lower melting temperature braze such as Incusil is pre-deposited onto the more conductive SiC, while a higher melting temperature braze such as Gapasil or TiCuNi is used on the less conductive Ti component. Such arrangements offer the possibility of designing for thermal transport during the reaction, chemical compatibility between individual braze or solder layers for the adjoining components, as well as thermophysical properties of the reactive joint. The present embodiments can be generalized to a variety of other configurations.

In various embodiments, some aspects of the invention set forth herein may be multiplied, combined, and removed from other aspects set forth herein without departing from the true scope of the invention.

In some embodiments, it should be understood that the terms braze, solder, Incusil, fusible material, and/or other like terms may be used interchangeably.

Other embodiments of the invention will be apparent to those skilled in the art from consideration of the specification and practice of the invention disclosed herein. It is intended that the specification and examples be considered as exemplary only, with a true scope of the invention being indicated by the following claims.

1. A method of simulating a behavior of an energy distribution within an assembly containing a reactive multilayer material, the method comprising the steps of:
providing an energy evolution equation, the energy evolution equation including an energy source term associated with a self-propagating reaction that originates within the reactive multilayer material, the self-propagating reaction having a known speed and heat of reaction;
discretizing the energy evolution equation; and
determining the behavior of the energy distribution in the assembly by integrating the discretized energy evolution equation using parameters associated with the assembly.

2. The method of claim 1, wherein the discretization of the energy evolution equation is based on a finite-difference method, a finite-element method, a spectral-element method, or a collocation method.

3. The method of claim 1, wherein the reactive multilayer material is a reactive multilayer foil and at least some of the parameters are associated with the reactive multilayer material.

4. The method of claim 1, wherein the assembly is a reactive joining configuration comprising a first component and a second component and at least some of the parameters are associated with the first component and the second component.

5. The method of claim 4, wherein the reactive multilayer material is disposed between the first component and the second component.

6. The method of claim 4, wherein the reactive joining configuration further comprises a first joining layer and a second joining layer and at least some of the parameters are associated with the first joining layer and the second joining layer.

7. The method of claim 6, wherein the reactive multilayer material is disposed between the first joining layer and the second joining layer.

8. The method of claim 6, wherein the first joining layer and the second joining layer are disposed between the first component and the second component.

9. The method of claim 4, wherein the first component and the second component have substantially the same chemical composition.

10. The method of claim 4, wherein the first component and the second component have different chemical compositions.

11. The method of claim 4, wherein the first component comprises a metal, metal alloy, bulk-metallic glass, ceramic, composite, or polymer and the second component comprises a metal, metal alloy, bulk-metallic glass, ceramic, composite, or polymer.

12. The method of claim 11, wherein the metal or metal alloy includes one or more of aluminum, titanium, copper, iron, and nickel.

13. The method of claim 11, wherein the ceramic includes one or more of silicon, carbon, boron, nitride, carbide, and aluminide.

14. The method of claim 6, wherein the first joining layer and the second joining layer have substantially the same chemical composition.

15. The method of claim 6, wherein the first joining layer and the second joining layer have different chemical compositions.

16. The method of claim 6, wherein the first joining layer is one or more of solder and braze and the second joining layer is one or more of solder and braze.

17. The method of claim 16, wherein the solder is one or more of lead, tin, zinc, gold, indium, silver, and antimony.

18. The method of claim 16, wherein the braze is one or more of silver, titanium, copper, indium, nickel, and gold.

19. The method of claim 1, wherein the energy evolution equation including the energy source term is
$$ρ \frac{\partial h}{\partial t} = ∇ \cdot q + \dot{Q}$$
wherein h enthalpy, ρ is density, t is time, q is the heat flux vector, and \dot{Q} is the energy release rate in the reactive multilayer material.

20. The method of claim 1, wherein the parameters include at least one of length, width, thickness, density, heat capacity, thermal conductivity, heat of fusion, melting temperature, heat of reaction, propagation velocity, atomic weight, and ignition location.

21. The method of claim 4, wherein the determining the behavior of the energy distribution includes determining at least one of: an amount of melting of at least one of the first component and the second component; a duration of melting of at least one of the first component and the second component; whether critical interfaces have been wetted; an amount of thermal exposure of at least one of the first component and the second component; and a temperature, a peak temperature, a temperature profile, or temperature distribution of at least one of the first component, the second component, and the reactive multilayer material.

22. The method of claim 6, wherein the determining the behavior of the energy distribution includes determining at least one of: an amount of melting of at least one of the first joining layer and the second joining layer; a duration of melting of at least one of the first joining layer and the second joining layer; whether critical interfaces have been wetted; an amount of thermal exposure of at least one of the first component and the second component; and a temperature, a peak temperature, a temperature profile, or temperature distribution of at least one of the first component, the second component, the first joining layer, the second joining layer, and the reactive multilayer material.

23. The method of claim 6, wherein the reactive joining configuration further comprises a third joining layer and a fourth joining layer;
wherein each of the third joining layer and the fourth joining layer is predeposited onto one of the reactive multilayer material, the first component, and the second component, and at least some of the parameters are associated with the third joining layer and the fourth joining layer.

24. The method of claim 23, wherein the third joining layer and the fourth joining layer have substantially the same chemical composition.

25. The method of claim 23, wherein the third joining layer and the fourth joining layer have different chemical compositions.

26. The method of claim 23, wherein the third joining layer is at least one of Incusil and Gapasil, and the fourth joining layer is at least one of Incusil and Gapasil.

27. A program storage device readable by a machine, tangibly embodying a program of instructions executable by the machine to perform method steps for simulating a behavior of an energy distribution within an assembly containing a reactive multilayer material, the method comprising the steps of:
providing an energy evolution equation, the energy evolution equation including an energy source term associated with a self-propagating reaction that originates within the reactive multilayer material, the self-propagating reaction having a known speed and heat of reaction;
discretizing the energy evolution equation; and
determining the behavior of the energy distribution in the assembly by integrating the discretized energy evolution equation using parameters associated with the assembly.

28. The method of claim 27, wherein the discretization of the energy evolution equation is based on a finite-difference method, a finite-element method, a spectral-element method, or a collocation method.

29. The method of claim 27, wherein the reactive multilayer material is a reactive multilayer foil and at least some of the parameters are associated with the reactive multilayer material.

30. The method of claim 27, wherein the assembly is a reactive joining configuration comprising a first component and a second component and at least some of the parameters are associated with the first component and the second component.

31. The method of claim 30, wherein the reactive multilayer material is disposed between the first component and the second component.

32. The method of claim 30, wherein the reactive joining configuration further comprises a first joining layer and a second joining layer and at least some of the parameters are associated with the first joining layer and the second joining layer.

33. The method of claim 32, wherein the reactive multilayer material is disposed between the first joining layer and the second joining layer.

34. The method of claim 32, wherein the first joining layer and the second joining layer are disposed between the first component and the second component.

35. The method of claim 30, wherein the first component and the second component have substantially the same chemical composition.

36. The method of claim 30, wherein the first component and the second component have different chemical compositions.

37. The method of claim 30, wherein the first component comprises a metal, metal alloy, bulk-metallic glass, ceramic, composite, or polymer and the second component comprises a metal, metal alloy, bulk-metallic glass, ceramic, composite, or polymer.

38. The method of claim 37, wherein the metal or metal alloy includes one or more of aluminum, titanium, copper, iron, and nickel.

39. The method of claim 37, wherein the ceramic includes one or more of silicon, carbon, boron, nitride, carbide, and aluminide.

40. The method of claim 32, wherein the first joining layer and the second joining layer have substantially the same chemical composition.

41. The method of claim 32, wherein the first joining layer and the second joining layer have different chemical compositions.

42. The method of claim 32, wherein the first joining layer is one or more of solder and braze and the second joining layer is one or more of solder and braze.

43. The method of claim 42, wherein the solder is one or more of lead, tin, zinc, gold, indium, silver, and antimony.

44. The method of claim 42, wherein the braze is one or more of silver, titanium, copper, indium, nickel, and gold.

45. The method of claim 27, wherein the energy evolution equation including the energy source term is
$$ρ \frac{\partial h}{\partial t} = ∇ \cdot q + \dot{Q}$$
wherein h enthalpy, ρ is density, t is time, q is the heat flux vector, and \dot{Q} is the energy release rate in the reactive multilayer material.

46. The method of claim 27, wherein the parameters include at least one of length, width, thickness, density, heat capacity, thermal conductivity, heat of fusion, melting temperature, heat of reaction, propagation velocity, atomic weight, and ignition location.

47. The method of claim 30, wherein the determining the behavior of the energy distribution includes determining at least one of: an amount of melting of at least one of the first component and the second component; a duration of melting of at least one of the first component and the second component; whether critical interfaces have been wetted; an amount of thermal exposure of at least one of the first component and the second component; and a temperature, a peak temperature, a temperature profile, or temperature distribution of at least one of the first component, the second component, and the reactive multilayer material.

48. The method of claim 32, wherein the determining the behavior of the energy distribution includes determining at least one of: an amount of melting of at least one of the first joining layer and the second joining layer; a duration of melting of at least one of the first joining layer and the second joining layer; whether critical interfaces have been wetted; an amount of thermal exposure of at least one of the first component and the second component; and a temperature, a peak temperature, a temperature profile, or temperature distribution of at least one of the first component, the second component, the first joining layer, the second joining layer, and the reactive multilayer material.

49. The method of claim 32, wherein the reactive joining configuration further comprises a third joining layer and a fourth joining layer;
wherein each of the third joining layer and the fourth joining layer is predeposited onto one of the reactive multilayer material, the first component, and the second component, and at least some of the parameters are associated with the third joining layer and the fourth joining layer.

50. The method of claim 49, wherein the third joining layer and the fourth joining layer have substantially the same chemical composition.

51. The method of claim 49, wherein the third joining layer and the fourth joining layer have different chemical compositions.

52. The method of claim 23, wherein the third joining layer is at least one of Incusil and Gapasil, and the fourth joining layer is at least one of Incusil and Gapasil.

53. A method, comprising:
selecting a reactive multilayer material;
selecting a first component and a second component for joining using the reactive multilayer material;
providing an energy evolution equation, the energy evolution equation including an energy source term associated with a self-propagating reaction that originates within the reactive multilayer material, the self-propagating reaction having a known speed and heat of reaction;
discretizing the energy evolution equation;
determining a behavior of an energy distribution in the first component, the second component, and the reactive multilayer material by integrating the discretized energy evolution equation using parameters associated with at least one of the first component, the second component, and the reactive multilayer material;
providing the first component, the second component, and the reactive multilayer material having the parameters;
positioning the reactive multilayer material between the first component and the second component; and
chemically transforming the reactive multilayer material so as to join the first component to the second component.

54. The method of claim 53, further comprising selecting a first joining layer and a second joining layer for joining the first component to the second component using the reactive multilayer material,
wherein the step of determining includes determining the behavior of the energy distribution in the first joining layer and the second joining layer by integrating the discretized energy evolution equation using parameters associated with at least one of the first joining layer and the second joining layer,
providing the first joining layer and the second joining layer having the parameters; and
positioning the first joining layer and the second joining layer between the first component and the second component,
wherein the step of chemically transforming causes a transformation of the first joining layer and the second joining layer.

55. The method of claim 54, wherein the step of positioning the first joining layer and the second joining layer includes depositing one of the joining layers on one of the first component, the second component, and the reactive multilayer material.

56. The method of claim 54, wherein one of the joining layers is a free-standing sheet,
wherein the step of positioning includes positioning the free-standing sheet between the reactive multilayer material and one of the first component and the second component.

57. The method of claim 53, wherein the reactive multilayer material is a reactive multilayer foil.

58. The method of claim 53, wherein the first component and the second component have substantially the same chemical composition.

59. The method of claim 53, wherein the first component and the second component have different chemical compositions.

60. The method of claim 53, wherein the first component comprises a metal, metal alloy, bulk-metallic glass, ceramic, composite, or polymer and the second component comprises a metal, metal alloy, bulk-metallic glass, ceramic, composite, or polymer.

61. The method of claim 60, wherein the metal or metal alloy includes one or more of aluminum, titanium, copper, iron, and nickel.

62. The method of claim 60, wherein the ceramic includes one or more of silicon, carbon, boron, nitride, carbide, and aluminide.

63. The method of claim 54, wherein the first joining layer and the second joining layer have substantially the same chemical composition.

64. The method of claim 54, wherein the first joining layer and the second joining layer have different chemical compositions.

65. The method of claim 54, wherein the first joining layer is one or more of solder and braze and the second joining layer is one or more of solder and braze.

66. The method of claim 65, wherein the solder is one or more of lead, tin, zinc, gold, indium, silver, and antimony.

67. The method of claim 65, wherein the braze is one or more of silver, titanium, copper, indium, nickel, and gold.

68. The method of claim 53, wherein the energy evolution equation is
$$ρ \frac{\partial h}{\partial t} = ∇ \cdot q + \dot{Q}$$
wherein h enthalpy, ρ is density, t is time, q is the heat flux vector, and \dot{Q} is the energy release rate in the reactive multilayer material.

69. The method of claim 53, wherein the parameters include at least one of length, width, thickness, density, heat capacity, thermal conductivity, heat of fusion, melting temperature, heat of reaction, propagation velocity, atomic weight, and ignition location.

70. The method of claim 53, wherein the determining the behavior of the energy distribution includes determining at least one of: an amount of melting of at least one of the first component and the second component; a duration of melting of at least one of the first component and the second component; whether critical interfaces have been wetted; an amount of thermal exposure of at least one of the first component and the second component; and a temperature, a peak temperature, a temperature profile, or temperature distribution of at least one of the first component, the second component, and the reactive multilayer material.

71. The method of claim 54, wherein the determining the behavior of the energy distribution includes determining at least one of: an amount of melting of at least one of the first joining layer and the second joining layer; a duration of melting of at least one of the first joining layer and the second joining layer; whether critical interfaces have been wetted; an amount of thermal exposure of at least one of the first component and the second component; and a temperature, a peak temperature, a temperature profile, or temperature distribution of at least one of the first component, the second component, the first joining layer, the second joining layer, and the reactive multilayer material.

72. The method of claim 54, further comprising selecting a third joining layer and a fourth joining layer for joining the first component to the second-component using the reactive multilayer material;
wherein the step of determining includes determining the behavior of the energy distribution in the third joining layer and the fourth joining layer by integrating the discretized energy evolution equation using parameters associated with at least one of the third joining layer and the fourth joining layer,
providing the third joining layer and the fourth joining layer having the parameters;
predepositing each of the third joining layer and the fourth joining layer on at least one of the first component, the second component, and the reactive multilayer material,
wherein the step of chemically transforming causes a transformation of the third joining layer and the fourth joining layer.

73. The method of claim 72, wherein the third joining layer and the fourth joining layer have substantially the same chemical composition.

74. The method of claim 72, wherein the third joining layer and the fourth joining layer have different chemical compositions.

75. The method of claim 72, wherein the third joining layer is at least one of Incusil and Gapasil, and the fourth joining layer is at least one of Incusil and Gapasil.

76. A joining method, comprising:
providing parameters associated with a first component, a second component, and a reactive multilayer material, the parameters having been determined by a determining method comprising the steps of:
providing an energy evolution equation, the energy evolution equation including an energy source term associated with a self-propagating reaction that originates within the reactive multilayer material, the self-propagating reaction having a known speed and heat of reaction;
discretizing the energy evolution equation; and
determining a behavior of an energy distribution in the first component, the second component, and the reactive multilayer material by integrating the discretized energy evolution equation using the parameters associated with at least one of the first component, the second component, and the reactive multilayer material;
providing the first component, the second component, and the reactive multilayer material having the parameters;
positioning the reactive multilayer material between the first component and the second component; and
chemically transforming the reactive multilayer material so as to join the first component to the second component.

77. The method of claim 76, further comprising providing the parameters associated with a first joining layer and a second joining layer,
wherein the step of determining includes determining the behavior of the energy distribution in the first joining layer and the second joining layer by integrating the discretized energy evolution equation using parameters associated with at least one of the first joining layer and the second joining layer,
providing the first joining layer and the second joining layer having the parameters;
positioning the first joining layer and the second joining layer between the first component and the second component,
wherein the step of chemically transforming causes a transformation of the first joining layer and the second joining layer.

78. The method of claim 77, wherein the step of positioning the first joining layer and the second joining layer includes depositing one of the joining layers on one of the first component, the second component, and the reactive multilayer material.

79. The method of claim 77, wherein one of the joining layers is a free-standing sheet,
wherein the step of positioning includes positioning the free-standing sheet between the reactive multilayer material and one of the first component and the second component.

80. The method of claim 76, wherein the reactive multilayer material is a reactive multilayer foil.

81. The method of claim 76, wherein the first component and the second component have substantially the same chemical composition.

82. The method of claim 76, wherein the first component and the second component have different chemical compositions.

83. The method of claim 76, wherein the first component comprises a metal, metal alloy, bulk-metallic glass, ceramic, composite, or polymer and the second component comprises a metal, metal alloy, bulk-metallic glass, ceramic, composite, or polymer.

84. The method of claim 83, wherein the metal or metal alloy includes one or more of aluminum, titanium, copper, iron, and nickel.

85. The method of claim 83, wherein the ceramic includes one or more of silicon, carbon, boron, nitride, carbide, and aluminide.

86. The method of claim 77, wherein the first joining layer and the second joining layer have substantially the same chemical composition.

87. The method of claim 77, wherein the first joining layer and the second joining layer have different chemical compositions.

88. The method of claim 77, wherein the first joining layer is one or more of solder and braze and the second joining layer is one or more of solder and braze.

89. The method of claim 88, wherein the solder is one or more of lead, tin, zinc, gold, indium, silver, and antimony.

90. The method of claim 88, wherein the braze is one or more of silver, titanium, copper, indium, nickel, and gold.

91. The method of claim 76, wherein the energy evolution equation including the energy source term is
$$ρ \frac{\partial h}{\partial t} = ∇ \cdot q + \dot{Q}$$
wherein h enthalpy, ρ is density, t is time, q is the heat flux vector, and \dot{Q} is the energy release rate in the reactive multilayer material.

92. The method of claim 76, wherein the parameters include at least one of length, width, thickness, density, heat capacity, thermal conductivity, heat of fusion, melting temperature, heat of reaction, propagation velocity, atomic weight, and ignition location.

93. The method of claim 76, wherein the determining the behavior of the energy distribution includes determining at least one of: an amount of melting of at least one of the first component and the second component; a duration of melting of at least one of the first component and the second component; whether critical interfaces have been wetted; an amount of thermal exposure of at least one of the first component and the second component; and a temperature, a peak temperature, a temperature profile, or temperature distribution of at least one of the first component, the second component, and the reactive multilayer material.

94. The method of claim 77, wherein the determining the behavior of the energy distribution includes determining at least one of: an amount of melting of at least one of the first joining layer and the second joining layer; a duration of melting of at least one of the first joining layer and the second joining layer; whether critical interfaces have been wetted; an amount of thermal exposure of at least one of the first component and the second component; and a temperature, a peak temperature, a temperature profile, or temperature distribution of at least one of the first component, the second component, the first joining layer, the second joining layer, and the reactive multilayer material.

95. The method of claim 77, further comprising providing the parameters associated with a third joining layer and a fourth joining layer,
wherein the step of determining includes determining the behavior of the energy distribution in the third joining layer and the fourth joining layer by integrating the discretized energy evolution equation using parameters associated with the third joining layer and the fourth joining layer,
providing the third joining layer and the fourth joining layer having the parameters;
positioning the third joining layer and the fourth joining layer between the first component and the second component,
wherein the step of chemically transforming causes a transformation of the third joining layer and the fourth joining layer.

96. The method of claim 95, wherein the third joining layer and the fourth joining layer have substantially the same chemical composition.

97. The method of claim 95, wherein the third joining layer and the fourth joining layer have different chemical compositions.

98. The method of claim 95, wherein the third joining layer is at least one of Incusil and Gapasil, and the fourth joining layer is at least one of Incusil and Gapasil.

99. A joint, comprising:
a first component joined to a second component; and
remnants of a chemical transformation of a reactive multilayer material associated with the first component and the second component,
wherein parameters of at least one of the first component, the second component, and the reactive multilayer material is predetermined based on a simulated behavior of an energy distribution within the first component, the second component, and the reactive multilayer material,
wherein the behavior is determined by integrating a discretization of an energy evolution equation using the parameters,
wherein the energy evolution equation includes an energy source term associated with a self-propagating front originating within the reactive multilayer material,
wherein the self-propagating front has a known speed and heat of reaction.

100. The joint of claim 99, further comprising a first joining layer and a second joining layer joining the first component to the second component,
wherein the parameters of at least one of the first component, the second component, the first joining layer, the second joining layer, and the reactive multilayer material is predetermined based on the simulated behavior of the energy distribution within the first component, the second component, the first joining layer, the second joining layer, and the reactive multilayer material.

101. The joint of claim 99, wherein the chemical transformation is an ignition.

102. The joint of claim 99, wherein the reactive multilayer material is a reactive multilayer foil.

103. The joint of claim 100, wherein the first joining layer and the second joining layer are disposed between the first component and the second component.

104. The joint of claim 99, wherein the first component and the second component have substantially the same chemical composition.

105. The joint of claim 99, wherein the first component and the second component have different chemical compositions.

106. The joint of claim 99, wherein the first component comprises a metal, metal alloy, bulk-metallic glass, ceramic, composite, or polymer and the second component comprises a metal, metal alloy, bulk-metallic glass, ceramic, composite, or polymer.

107. The joint of claim 106, wherein the metal or metal alloy includes one or more of aluminum, titanium, copper, iron, and nickel.

108. The joint of claim 106, wherein the ceramic includes one or more of silicon, carbon, boron, nitride, carbide, and aluminide.

109. The joint of claim 100, wherein the first joining layer and the second joining layer have substantially the same chemical composition.

110. The joint of claim 100, wherein the first joining layer and the second joining layer have different chemical compositions.

111. The joint of claim 100, wherein the first joining layer is one or more of solder and braze and the second joining layer is one or more of solder and braze.

112. The joint of claim 111, wherein the solder is one or more of lead, tin, zinc, gold, indium, silver, and antimony.

113. The joint of claim 111, wherein the braze is one or more of silver, titanium, copper, indium, nickel, and gold.

114. The joint of claim 99, wherein the energy evolution equation including the energy source term is
$$ρ \frac{\partial h}{\partial t} = ∇ \cdot q + \dot{Q}$$
wherein h enthalpy, ρ is density, t is time, q is the heat flux vector, and \dot{Q} is the energy release rate in the reactive multilayer material.

115. The joint of claim 99, wherein the parameters include at least one of length, width, thickness, density, heat capacity, thermal conductivity, heat of fusion, melting temperature, heat of reaction, propagation velocity, atomic weight, and ignition location.

116. The joint of claim 99, wherein the determining the behavior of the energy distribution includes determining at least one of: an amount of melting of at least one of the first component and the second component; a duration of melting of at least one of the first component and the second component; whether critical interfaces have been wetted; an amount of thermal exposure of at least one of the first component and the second component; and a temperature, a peak temperature, a temperature profile, or temperature distribution of at least one of the first component, the second component, and the reactive multilayer material.

117. The joint of claim 100, wherein the determining the behavior of the energy distribution includes determining at least one of: an amount of melting of at least one of the first joining layer and the second joining layer; a duration of melting of at least one of the first joining layer and the second joining layer; whether critical interfaces have been wetted; an amount of thermal exposure of at least one of the first component and the second component; and a temperature, a peak temperature, a temperature profile, or temperature distribution of at least one of the first component, the second component, the first joining layer, the second joining layer, and the reactive multilayer material.

118. The joint of claim 99, further comprising a third joining layer and a fourth joining layer joining the first component to the second component,
wherein the parameters of at least one of the first component, the second component, the first joining layer, the second joining layer, the third joining layer, the fourth joining layer, and the reactive multilayer material are predetermined based on the simulated behavior of the energy distribution within the first component, the second component, the first joining layer, the second joining layer, the third joining layer, the fourth joining layer, and the reactive multilayer material.

119. The joint of claim 118, wherein the third joining layer and the fourth joining layer have substantially the same chemical composition.

120. The joint of claim 118, wherein the third joining layer and the fourth joining layer have different chemical compositions.

121. The joint of claim 118, wherein the third joining layer is at least one of Incusil, and Gapasil, and the fourth joining layer is at least one of Incusil, and Gapasil.

122. A joint, comprising:
a first component joined to a second component; and
remnants of a chemical transformation of a reactive multilayer material;
wherein the first component has a chemical composition different from the second component.

123. The joint of claim 122, further comprising a first joining layer and a second joining layer joining the first component to the second component;
wherein the first joining layer has a chemical composition different from the second joining layer.

124. The joint of claim 122, wherein the reactive multilayer material is a reactive multilayer foil.

125. The joint of claim 123, wherein the first joining layer and the second joining layer are disposed between the first component and the second component.

126. The joint of claim 122, wherein the first component comprises a metal, metal alloy, bulk-metallic glass, ceramic, composite, or polymer and the second component comprises a metal, metal alloy, bulk-metallic glass, ceramic, composite, or polymer.

127. The joint of claim 126, wherein the metal or metal alloy includes one or more of aluminum, titanium, copper, iron, and nickel.

128. The joint of claim 126, wherein the ceramic includes one or more of silicon, carbon, boron, nitride, carbide, and aluminide.

129. The joint of claim 123, wherein the first joining layer is one or more of solder and braze and the second joining layer is one or more of solder and braze.

130. The joint of claim 129, wherein the solder is one or more of lead, tin, zinc, gold, indium, silver, and antimony.

131. The joint of claim 129, wherein the braze is one or more of silver, titanium, copper, indium, nickel, and gold.

132. The joint of claim 123, further comprising a third joining layer and a fourth joining layer joining the first component to the second component.

133. The joint of claim 132, wherein the third joining layer and the fourth joining layer have substantially the same chemical composition.

134. The joint of claim 132, wherein the third joining layer and the fourth joining layer have different chemical compositions.

135. The joint of claim 132, wherein the third joining layer is at least one of Incusil, and Gapasil, and the fourth joining layer is at least one of Incusil, and Gapasil.
